(19) United States
(12) Patent Application Publication
(10) Pub. No.: US 2025/0241242 A1
(43) Pub. Date: Jul. 31, 2025

(54) Agricultural Harvester Header Compatibility Control

(71) Applicant: DEERE & COMPANY, MOLINE, IL (US)

(72) Inventors: PARAG P. ANGAL, PUNE (IN); DUANE M. BOMLENY, GENESEO, IL (US); RAJU PATEL, DHAMNOD (IN)

(21) Appl. No.: 18/428,002

(22) Filed: Jan. 31, 2024

(51) Int. Cl. A01D 41/14; A01D 69/03

(52) U.S. Cl. CPC A01D 41/141; A01D 69/03

(57) ABSTRACT

An agricultural harvester include a header compatibility control system having a first sensor measures characteristic of the agricultural harvester and generates a signal indicative of the characteristic and a controller. The controller includes a processor and a memory having a compatibility control algorithm. The processor is operable to execute the compatibility control algorithm to: receive the signal indicative of the characteristic from the first sensor to determine a load; determine, based on the signal, whether the load is equal to or greater than a first threshold; calculate, if the load is determined to be equal to or greater than the first threshold, a restricted condition based on the load, and control the agricultural harvester to operate in the restricted condition in response to the load being equal to or greater than the first threshold.

### TECHNICAL FIELD

The present disclosure relates generally to the implement compatibility control of agricultural harvesters, in particular, to the header compatibility control of agricultural harvesters.

### BACKGROUND

Agricultural harvesters harvest crop from a field and process the harvested crop to separate grain from crop residue. Front end equipment (i.e., headers) is selectively coupled to the agricultural harvesters and operate to engage the crop, such as during a harvesting operation. Some headers are designed wider than others to increase productivity, and the wider header may be heavier than narrower headers. Different agricultural harvesters may have different capabilities to support different headers.

### SUMMARY

According to a disclosure, an agricultural harvester includes a main frame, a ground engaging device, a feederhouse, and a header compatibility control system. The main frame has a first end and a second end spaced from the first end along a central longitudinal axis of the main frame. The ground engaging device is coupled to the main frame and is used to move the main frame in a direction of travel during an operation. The feederhouse is coupled to the main frame and is used for attachment to a header. The header compatibility control system including a first sensor and a controller. The first sensor is used to measure a characteristic of the agricultural harvester and to generate a signal indicative of the characteristic. The controller includes a processor and a memory having a compatibility control algorithm stored therein. The processor is operable to execute the compatibility control algorithm to: receive the signal indicative of the characteristic from the first sensor to determine a load of the agricultural harvester; determine, based on the signal, whether the load is equal to or greater than a first threshold, and the first threshold is stored in the memory; calculate, if the load is determined to be equal to or greater than the first threshold, a restricted condition based on the load; and control the agricultural harvester to operate in the restricted condition in response to the load being equal to or greater than the first threshold.

In one aspect of the disclosure, the processor is operable to execute the compatibility control algorithm to: determine, based on the signal, whether the load is equal to or less than a second threshold, which is stored in the memory and control the agricultural harvester to operate in the restricted condition in response the load being equal to or less than the second threshold.

In one aspect of the disclosure, in the restricted condition, the processor is operable to execute the compatibility control algorithm to restrict the agricultural harvester to travel at or below a pre-determined speed.

In one aspect of the disclosure, the processor is operable to execute the compatibility control algorithm to downshift gears of a gearbox of the agricultural harvester or to initiate a brake of the ground engaging device to restrict the agricultural harvester to travel at or below the pre-determined speed.

In one aspect of the disclosure, in the restricted condition, the processor is operable to execute the compatibility control algorithm to decrease an output of a motor of the agricultural harvester to restrict the agricultural harvester to travel at or below the pre-determined speed.

In one aspect of the disclosure, the agricultural harvester includes an actuator coupled between the feederhouse and the main frame, and the feederhouse is pivotably coupled to the main frame about a pivot axis, and the actuator is used to lift and lower the feederhouse.

In one aspect of the disclosure, the processor is used to calculate a load of the header based on the signal from the first sensor.

In one aspect of the disclosure, in the restricted condition, the processor is operable to execute the compatibility control algorithm to extend or retract the actuator to lower a height of the header equal to or below a pre-determined height.

In one aspect of the disclosure, the load of the header results from the weight of the header and a reaction from the crop material engaged with the header.

In one aspect of the disclosure, the agricultural harvester includes a hydraulic pressure controller hydraulically connected to the actuator. The hydraulic pressure controller is coupled to the controller and used to control a hydraulic pressure of a hydraulic fluid entering the actuator. In the restricted condition, the processor is operable to execute the compatibility control algorithm to activate the hydraulic pressure controller to restrict the hydraulic pressure to be equal to or less than a first hydraulic pressure value.

In one aspect of the disclosure, the hydraulic pressure controller includes a pressure regulating valve disposed upstream the actuator. The processor is operable to execute the compatibility control algorithm to adjust the hydraulic pressure of the fluid entering the actuator.

In one aspect of the disclosure, the hydraulic pressure controller includes a flow control valve and an accumulator disposed downstream the flow control valve. The processor is operable to execute the compatibility control algorithm to control the flow control valve to restrict the hydraulic pressure of the actuator to be equal to a first hydraulic pressure of the accumulator.

In one aspect of the disclosure, the agricultural harvester includes a position sensor used to measure a position of the feederhouse and to transmit a signal indicative of the position of the feederhouse. The processor calculates a moment based on the signal from the first sensor and the signal from the position sensor.

In one aspect of the disclosure, the agricultural harvester includes an axle coupled between the main frame the ground engaging device. The first sensor is coupled to the axle to measure a characteristic of the axle.

In one aspect of the disclosure, the agricultural harvester includes an input device and an operation sensor. The input device is coupled to the controller and is used to transmit a signal indicative of an input to the controller. The operation sensor is used to detect an operational parameter of the agricultural harvester and transmit a signal indicative of the operational parameter to the controller. The memory includes an operation state classifier algorithm. The processor is operable to execute the operation state classifier algorithm to classify an operation state derived from the signal indicative of the input and the signal indicative of the operational parameter and to execute the compatibility control algorithm to calculate the restricted condition based on the operation state.

In one aspect of the disclosure, the operation state includes at least one of harvesting parallel to rows, angled to rows, brake assisted turns, field transport, field exits, road transport, and field border crossing.

In one aspect of the disclosure, the agricultural harvester includes an image sensor used to capture an image of a ground in front of the agricultural harvester and to transmit a signal indicative of the image to the controller. The processor is operable to execute the compatibility control algorithm to calculate the restricted condition based on the signal indicative of the image.

In one aspect of the disclosure, the agricultural harvester includes an input device coupled to the controller and used to input a travel path. The memory stores a topographic map covering a field. The processor is operable to execute the compatibility control algorithm to extract data from the topographic map corresponding to the travel path to obtain the data of a topographic feature along the travel path and to calculate the restricted condition based on the data of the topographic feature.

In one aspect of the disclosure, the topographic feature includes at least one of sizes of bumps, distances between the bumps, a slope of the travel path, a rate of a change of the slope, and a hardness of the soil, etc.

In one aspect of the disclosure, in the restricted condition, the controller is used to restrict the agricultural harvester to travel at or below a pre-determined speed and to decrease the height of the header equal to or less than a pre-determined height.

In one aspect of the disclosure, the header is an extendable header, and in the restricted condition, the processor is operable to execute the compatibility control algorithm to decrease a length of the header to a pre-determined length of the header.

According to a disclosure, an agricultural harvester includes a main frame, a ground engaging device, a feederhouse, and a header compatibility control system. The main frame has a first end and a second end spaced from the first end along a central longitudinal axis of the main frame. The ground engaging device is coupled to the main frame and is used to move the main frame in a direction of travel during an operation. The feederhouse is coupled to the main frame and is used for attachment to a header. The header compatibility control system including a first sensor and a controller. The first sensor is used to measure a characteristic of the agricultural harvester and to generate a signal indicative of the characteristic. The controller includes a processor and a memory having a compatibility control algorithm stored therein. The processor is operable to execute the compatibility control algorithm to: receive the signal indicative of the characteristic from the first sensor to determine a load of the agricultural harvester; convert the load into a moment; determine, based on the signal, whether the moment is equal to or greater than a first threshold, and the first threshold is stored in the memory; calculate, if the moment is determined to be equal to or greater than the first threshold, a restricted condition based on the moment; and control the agricultural harvester to operate in the restricted condition in response to the moment being equal to or greater than the first threshold.

In one aspect of the disclosure, the processor calculates a moment based on the signal from the first sensor and a position of the feederhouse.

In one aspect of the disclosure, the processor is operable to execute the compatibility control algorithm to: determine, based on the signal, whether the moment is equal to or less than a second threshold, which is stored in the memory; and control the agricultural harvester to operate in the restricted condition in response to the moment being equal to or less than the second threshold.

In one aspect of the disclosure, in the restricted condition, the processor is operable to execute the compatibility control algorithm to restrict the agricultural harvester to travel at or below a pre-determined speed.

In one aspect of the disclosure, the processor is operable to execute the compatibility control algorithm to downshift gears of a gearbox of the agricultural harvester or to initiate a brake of the ground engaging device to restrict the agricultural harvester to travel at or below the pre-determined speed.

In one aspect of the disclosure, in the restricted condition, the processor is operable to execute the compatibility control algorithm to decrease an output of a motor of the agricultural harvester to restrict the agricultural harvester to travel at or below the pre-determined speed.

In one aspect of the disclosure, the agricultural harvester includes an actuator coupled between the feederhouse and the main frame, and the feederhouse is pivotably coupled to the main frame about a pivot axis, and the actuator is used to lift and lower the feederhouse.

In one aspect of the disclosure, the processor is used to calculate a load of the header based on the signal from the first sensor.

In one aspect of the disclosure, in the restricted condition, the processor is operable to execute the compatibility control algorithm to extend or retract the actuator to lower a height of the header equal to or below a pre-determined height.

In one aspect of the disclosure, the load of the header results from the weight of the header and a reaction from the crop material engaged with the header.

In one aspect of the disclosure, the agricultural harvester includes a hydraulic pressure controller hydraulically connected to the actuator. The hydraulic pressure controller is coupled to the controller and used to control a hydraulic pressure of a hydraulic fluid entering the actuator. In the restricted condition, the processor is operable to execute the compatibility control algorithm to activate the hydraulic pressure controller to restrict the hydraulic pressure to be equal to or less than a first hydraulic pressure value.

In one aspect of the disclosure, the hydraulic pressure controller includes a pressure regulating valve disposed upstream the actuator. The processor is operable to execute the compatibility control algorithm to adjust the hydraulic pressure of the fluid entering the actuator.

In one aspect of the disclosure, the hydraulic pressure controller includes a flow control valve and an accumulator disposed downstream the flow control valve. The processor is operable to execute the compatibility control algorithm to control the flow control valve to restrict the hydraulic pressure of the actuator to be equal to a first hydraulic pressure of the accumulator.

In one aspect of the disclosure, the agricultural harvester includes a position sensor used to measure the position of the feederhouse and to transmit a signal indicative of the position of the feederhouse. The processor calculates the moment based on the signal from the first sensor and the signal from the position sensor.

In one aspect of the disclosure, the agricultural harvester includes an axle coupled between the main frame the ground engaging device. The first sensor is coupled to the axle to measure a characteristic of the axle.

In one aspect of the disclosure, the agricultural harvester includes an input device and an operation sensor. The input device is coupled to the controller and is used to transmit a signal indicative of an input to the controller. The operation sensor is used to detect an operational parameter of the agricultural harvester and transmit a signal indicative of the operational parameter to the controller. The memory includes an operation state classifier algorithm. The processor is operable to execute the operation state classifier algorithm to classify an operation state derived from the signal indicative of the input and the signal indicative of the operational parameter and to execute the compatibility control algorithm to calculate the restricted condition based on the operation state.

In one aspect of the disclosure, the operation state includes at least one of harvesting parallel to rows, angled to rows, brake assisted turns, field transport, field exits, road transport, and field border crossing.

In one aspect of the disclosure, the agricultural harvester includes an image sensor used to capture an image of a ground in front of the agricultural harvester and to transmit a signal indicative of the image to the controller. The processor is operable to execute the compatibility control algorithm to calculate the restricted condition based on the signal indicative of the image.

In one aspect of the disclosure, the agricultural harvester includes an input device coupled to the controller and used to input a travel path. The memory stores a topographic map covering a field. The processor is operable to execute the compatibility control algorithm to extract data from the topographic map corresponding to the travel path to obtain the data of a topographic feature along the travel path and to calculate the restricted condition based on the data of the topographic feature.

In one aspect of the disclosure, the topographic feature includes at least one of sizes of bumps, distances between the bumps, a slope of the travel path, a rate of a change of the slope, and a hardness of the soil.

In one aspect of the disclosure, in the restricted condition, the controller is used to restrict the agricultural harvester to travel at or below a pre-determined speed and to decrease the height of the header equal to or less than a pre-determined height.

In one aspect of the disclosure, the header is an extendable header, and in the restricted condition, the processor is operable to execute the compatibility control algorithm to decrease a length of the header to a pre-determined length of the header.

According to a disclosure, a method of compatibility control of an agricultural harvester comprising: measuring a characteristic of the agricultural harvester and generating signals indicative of the characteristic by a first sensor; receiving a signal indicative of the characteristic; determining a load of the agricultural harvester based on the signal indicative of the characteristic; converting the load into a moment; comparing the moment with a first threshold; calculating a restricted condition based on the moment in response to the moment being greater than the first threshold; and controlling the harvester to operate in the restricted condition.

Accordingly to a disclosure, an agricultural harvester system includes an agricultural harvester and a header removably connected to the agricultural harvester. The agricultural harvester system includes a main frame, a ground engaging device, a feederhouse, and a header compatibility control system. The main frame has a first end and a second end spaced from the first end along a central longitudinal axis of the main frame. The ground engaging device is coupled to the main frame and is configured to move the main frame in a direction of travel during an operation. The feederhouse is coupled to the main frame and is configured for attachment to the header. The header compatibility control system includes an electronic component and a controller. The electronic component is positioned on the header has configuration data of the header. The controller has a processor and a memory having a compatibility control algorithm stored therein. The processor is operable to execute the compatibility control algorithm to: receive the signals indicative of the configuration data from the electronic component; determine, based on the signals, whether a value of the configuration data is equal to or greater than a first reference value, wherein the first reference value is stored in the memory; calculate, if the value of the configuration data is determined to be equal to or greater than the first reference value, a restricted condition based on the value of the configuration data; and control the agricultural harvester to operate in the restricted condition in response to the value of the configuration data being equal to or greater than the first reference value.

In one aspect of the disclosure, the processor is operable to execute the compatibility control algorithm to: determine, based on the signal, whether the value is equal to or less than a second threshold, which is stored in the memory; and control the agricultural harvester to operate in the restricted condition in response the value of the configuration data being equal to or less than the second threshold.

In one aspect of the disclosure, the configuration data includes one of the weight, size, and mass of inertia.

In one aspect of the disclosure, the configuration data is the weight of the header and the first reference value is a first weight threshold.

In one aspect of the disclosure, the configuration data is the moment of inertia of the header and the first reference value is a first moment of inertia threshold.

In one aspect of the disclosure, in the restricted condition, the processor is operable to execute the compatibility control algorithm to restrict the agricultural harvester to travel at or below a pre-determined speed.

In one aspect of the disclosure, the agricultural harvester system includes an actuator coupled between the feederhouse and the main frame. The feederhouse is pivotably coupled to the main frame about a pivot axis, and the actuator is configured to lift and lower the feederhouse. In the restricted condition, the processor is operable to execute the compatibility control algorithm to extend or retract the actuator to lower a height of the header equal to or below a pre-determined height.

In one aspect of the disclosure, the agricultural harvester system includes a hydraulic circuit having an actuator, an accumulator, and a pressure regulating valve disposed upstream the actuator and the accumulator. In the restricted condition, the processor is operable to execute the compatibility control algorithm to decrease a hydraulic pressure of the actuator and the accumulator to increase a suspension.

In one aspect of the disclosure, the actuator is coupled between the feederhouse and the main frame. The feederhouse is pivotably coupled to the main frame. The actuator is configured to lift and lower the feederhouse.

In one aspect of the disclosure, the header include an attachment frame and a center frame pivotable relative to the attachment frame. The actuator is coupled between the center frame and the attachment frame and is configured to provide the suspension between the center frame and the attachment frame.

In one aspect of the disclosure, the header include a center frame and a wing frame pivotable relative to the center frame. The actuator is coupled between the center frame and the wing frame and is configured to provide the suspension between the center frame and the wing frame.

In one aspect of the disclosure, the header is pivotable relative to the feederhouse. The actuator is a tilt actuator coupled between the header and the feederhouse and is configured to provide the suspension between the header and the feederhouse.

Accordingly to a disclosure, an agricultural harvester system includes an agricultural harvester and a header removably connected to the agricultural harvester. The agricultural harvester system includes a main frame, a ground engaging device, a feederhouse, a tilt actuator, and a header compatibility control system. The main frame has a first end and a second end spaced from the first end along a central longitudinal axis of the main frame. The ground engaging device is coupled to the main frame and is configured to move the main frame in a direction of travel during an operation. The feederhouse is coupled to the main frame and is configured for attachment to the header. The tilt actuator is coupled between the feederhouse and the header and is configured to pivot the header relative to the feederhouse with a twist load and an angular acceleration. The header compatibility control system includes a sensor and a controller. The sensor is configured to measure a characteristic of the tilt actuator and to generate a signal indicative of the characteristic. The controller has a processor and a memory having a compatibility control algorithm stored therein. The processor is operable to execute the compatibility control algorithm to: actuate the tilt actuator to generate the twist load; receive the signals indicative of the characteristic from the sensor to calculate the twist load; calculate a moment of inertia of the header based on the twist load and the angular acceleration; determine, based on the signal, whether the moment of inertia is equal to or greater than a first threshold, wherein the first threshold is stored in the memory; calculate, if the moment of inertia is determined to be equal to or greater than the first threshold, a restricted condition based on the moment of inertia; and control the agricultural harvester to operate in the restricted condition in response to the moment of inertia being equal to or greater than the first threshold.

In one aspect of the disclosure, in the restricted condition, the processor is operable to execute the compatibility control algorithm to restrict the agricultural harvester to travel at or below a pre-determined speed.

In one aspect of the disclosure, the agricultural harvester system includes an actuator coupled between the feederhouse and the main frame. The feederhouse is pivotably coupled to the main frame about a pivot axis, and the actuator is configured to lift and lower the feederhouse. In the restricted condition, the processor is operable to execute the compatibility control algorithm to extend or retract the actuator to lower a height of the header equal to or below a pre-determined height.

In one aspect of the disclosure, the agricultural harvester system includes a hydraulic circuit having an actuator, an accumulator, and a pressure regulating valve disposed upstream the actuator and the accumulator. In the restricted condition, the processor is operable to execute the compatibility control algorithm to decrease a hydraulic pressure of the actuator and the accumulator to increase a suspension.

In one aspect of the disclosure, the actuator is coupled between the feederhouse and the main frame. The feederhouse is pivotably coupled to the main frame. The actuator is configured to lift and lower the feederhouse.

In one aspect of the disclosure, the header include an attachment frame and a center frame pivotable relative to the attachment frame. The actuator is coupled between the center frame and the attachment frame and is configured to provide the suspension between the center frame and the attachment frame.

In one aspect of the disclosure, the header include a center frame and a wing frame pivotable relative to the center frame. The actuator is coupled between the center frame and the wing frame and is configured to provide the suspension between the center frame and the wing frame.

In one aspect of the disclosure, the header is pivotable relative to the feederhouse. The actuator is a tilt actuator coupled between the header and the feederhouse and is configured to provide the suspension between the header and the feederhouse.

Accordingly to a disclosure, an agricultural harvester system includes an agricultural harvester and a header removably connected to the agricultural harvester. The agricultural harvester system includes a main frame, a ground engaging device, a feederhouse, a tilt actuator, and a header compatibility control system. The main frame has a first end and a second end spaced from the first end along a central longitudinal axis of the main frame. The ground engaging device is coupled to the main frame and is configured to move the main frame in a direction of travel during an operation. a feederhouse coupled to the main frame and configured for attachment to the header, which is pivotable relative to the feederhouse around a pin. The tilt actuator is coupled between the feederhouse and the header and is configured to receive a twist load from the header during the operation. The header compatibility control system includes a sensor and a controller. The sensor is configured to measure a characteristic of the tilt actuator or the pin and to generate a signal indicative of the characteristic. The controller has a processor and a memory having a compatibility control algorithm stored therein. The processor is operable to execute the compatibility control algorithm to: receive the signals indicative of the characteristic from the sensor; calculate the twist load based on the signal; determine whether the twist load is equal to or greater than a first threshold, wherein the first threshold is stored in the memory; calculate, if the twist load is determined to be equal to or greater than the first threshold, a restricted condition based on the twist load; and control the agricultural harvester to operate in the restricted condition in response to the twist load being equal to or greater than the first threshold.

In one aspect of the disclosure, in the restricted condition, the processor is operable to execute the compatibility control algorithm to restrict the agricultural harvester to travel at or below a pre-determined speed.

In one aspect of the disclosure, the agricultural harvester system includes an actuator coupled between the feederhouse and the main frame. The feederhouse is pivotably coupled to the main frame about a pivot axis, and the actuator is configured to lift and lower the feederhouse. In the restricted condition, the processor is operable to execute the compatibility control algorithm to extend or retract the actuator to lower a height of the header equal to or below a pre-determined height.

In one aspect of the disclosure, the agricultural harvester system includes a hydraulic circuit having an actuator, an accumulator, and a pressure regulating valve disposed upstream the actuator and the accumulator. In the restricted condition, the processor is operable to execute the compatibility control algorithm to decrease a hydraulic pressure of the actuator and the accumulator to increase a suspension.

In one aspect of the disclosure, the actuator is coupled between the feederhouse and the main frame. The feederhouse is pivotably coupled to the main frame. The actuator is configured to lift and lower the feederhouse.

In one aspect of the disclosure, the header include an attachment frame and a center frame pivotable relative to the attachment frame. The actuator is coupled between the center frame and the attachment frame and is configured to provide the suspension between the center frame and the attachment frame.

In one aspect of the disclosure, the header include a center frame and a wing frame pivotable relative to the center frame. The actuator is coupled between the center frame and the wing frame and is configured to provide the suspension between the center frame and the wing frame.

In one aspect of the disclosure, the header is pivotable relative to the feederhouse. The actuator is a tilt actuator coupled between the header and the feederhouse and is configured to provide the suspension between the header and the feederhouse.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1A is a side elevational view showing an agricultural harvester.

FIG. 1B is a side view of an extendable header of the agricultural harvester in a rearward position.

FIG. 1C is a side view of an extendable header of the agricultural harvester in a forward position.

FIG. 1D is a schematic side view of an attachment frame and a center frame of the header of the combine harvester.

FIG. 1E is a schematic back view of a header having a center frame and two wing frames.

FIG. 1F is a schematic front view of a header tilted around an axis.

FIG. 1G is a schematic rear view of the header of FIG. 1E coupled to two tilt actuators.

FIG. 2 is a block diagram showing the agricultural harvester having a power system that determines the travel speed of the agricultural harvester, movement of an actuator, and the hydraulic pressure of the actuator.

FIG. 3 is a block diagram showing the multiple inputs for the processor to calculate a restricted condition, embodied by multiple outputs for multiple components in the agricultural harvester.

FIG. 4 is a flow chart demonstrating a method corresponding to a first implementation of a processor execute a compatibility control algorithm.

FIG. 5 is a flow chart demonstrating a method corresponding to a second implementation of the processor execute a compatibility control algorithm.

FIG. 6 is a flow chart demonstrating a method corresponding to a third implementation of the processor execute a compatibility control algorithm.

FIG. 7 is a flow chart demonstrating a method corresponding to a fourth implementation of the processor execute a compatibility control algorithm.

FIG. 8 is a flow chart demonstrating a method corresponding to a fifth implementation of the processor execute a compatibility control algorithm.

FIG. 9 is a flow chart demonstrating a method corresponding to a sixth implementation of the processor execute a compatibility control algorithm.

FIG. 10 is a flow chart demonstrating a method corresponding to a seventh implementation of the processor execute a compatibility control algorithm.

FIG. 11 is a flow chart demonstrating a method corresponding to an eighth implementation of the processor execute a compatibility control algorithm.

Like reference numerals are used to indicate like elements throughout the several figures.

### DETAILED DESCRIPTION

The present disclosure includes an agricultural harvester(s) (e.g., a combine) that is able to connect a front-end equipment (i.e., a header) and determine whether the header is compatible, when the agricultural harvester is operated in a restricted condition calculated by a controller of the agricultural harvester. The compatibility of the header referred thereto is the configuration of header (e.g., the weight, size, moment of inertia, and the components of the header cutting or transporting the crop), properly connected or engaged on the body of the agricultural harvester during the operation of the agricultural harvester, will not substantially decrease the fatigue life of the agricultural harvester. The spike of the load or moment from the header to the agricultural harvester may occur during the operation of the agricultural harvester, and the high frequency of high load (high moment) occurs during a given duty cycle may substantially decrease the fatigue life of components of the agricultural harvester if the header is not compatible to the agricultural harvester. The present disclosure includes an agricultural harvester that may achieve the balance between the productivity (using wide, heavy header) and the life of the component(s) of the agricultural harvester, when the agricultural harvester is operated in a restricted condition calculated by a controller. The present disclosure also describes a method(s) of capability control of an agricultural harvester that may achieve the balance between the productivity (wide, heavy header) and the life of the component(s) of the agricultural harvester when the agricultural harvester is operated in a restricted condition. It is noted that the fatigue life of the agricultural harvester may refer to a feederhouse, a pivot unit where the feederhouse coupled to a main frame of the agricultural harvester, the main frame, an axle, or other components of the agricultural harvester.

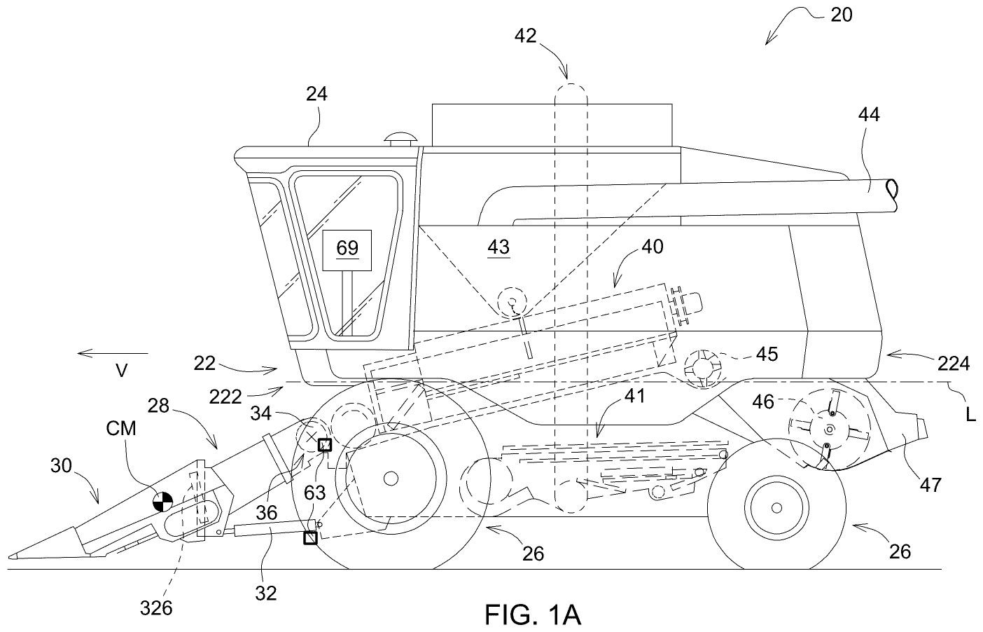

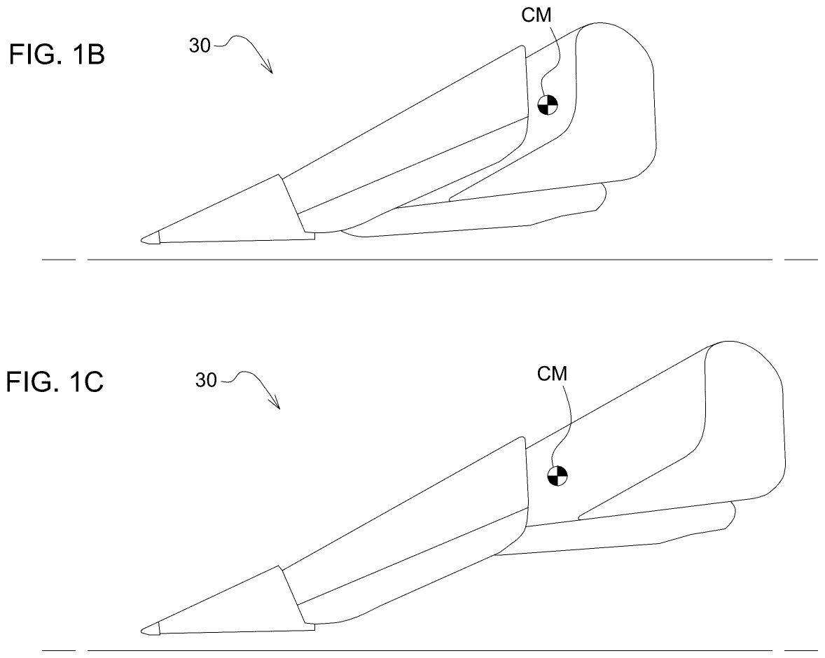

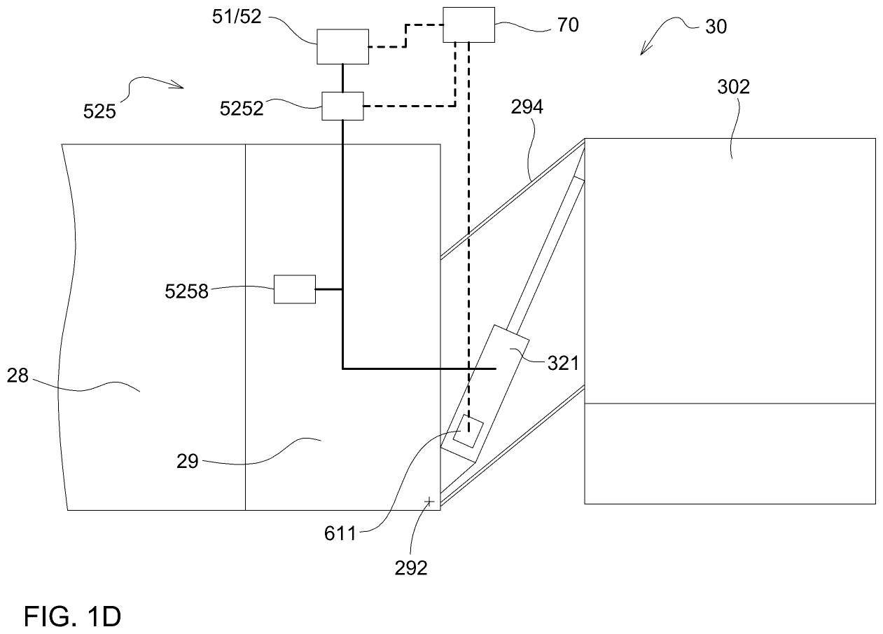

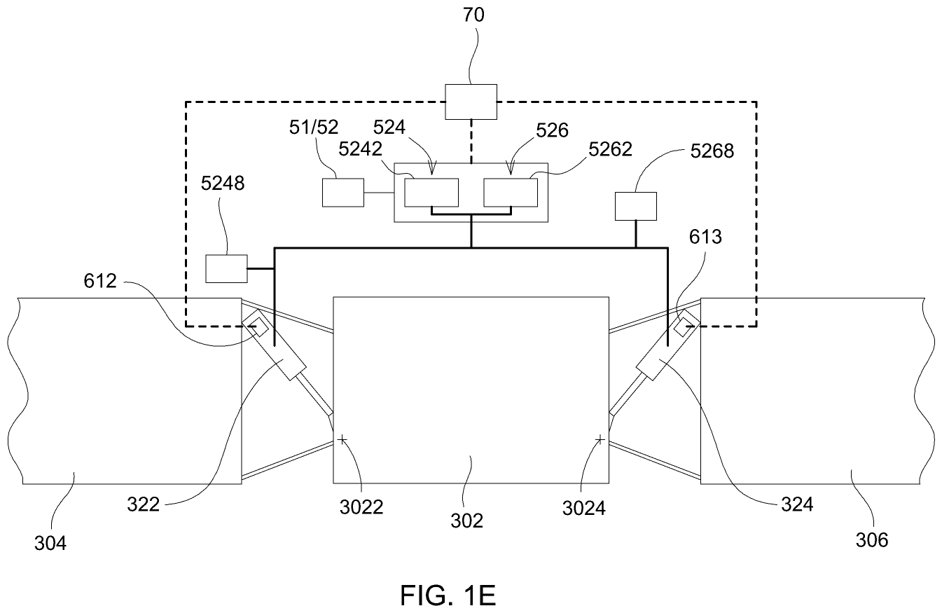

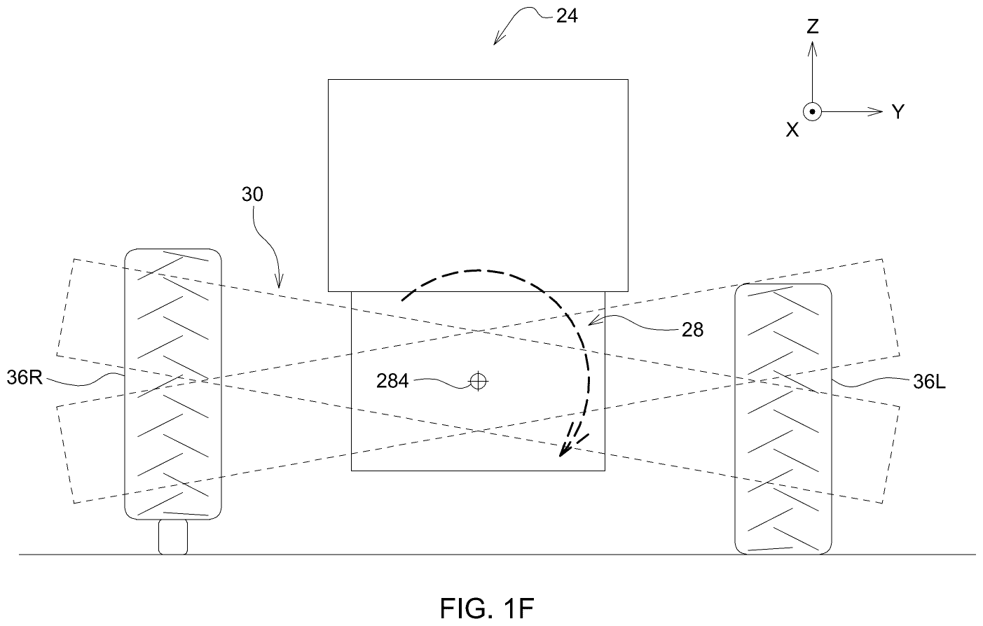

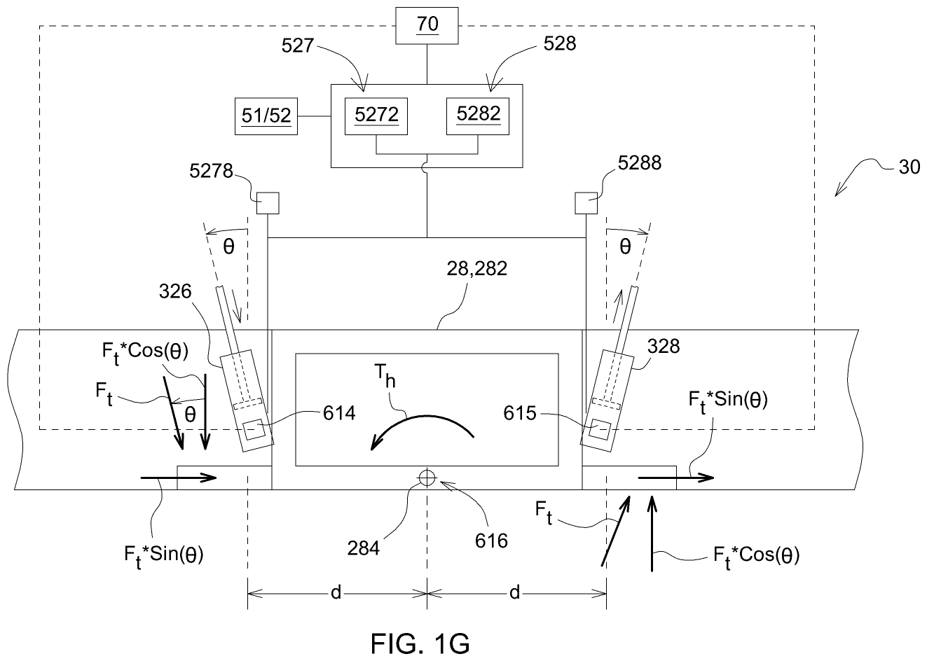

Referring to FIG. 1A, an agricultural harvester 20 is configured to move in a forward direction of travel over a field to harvest crop from the field. The agricultural harvester 20 processes the crop, separating grain from crop residue (e.g., straw, stalks, cobs, leaves, chaff), storing the separated grain, and returning crop residue back to the field.

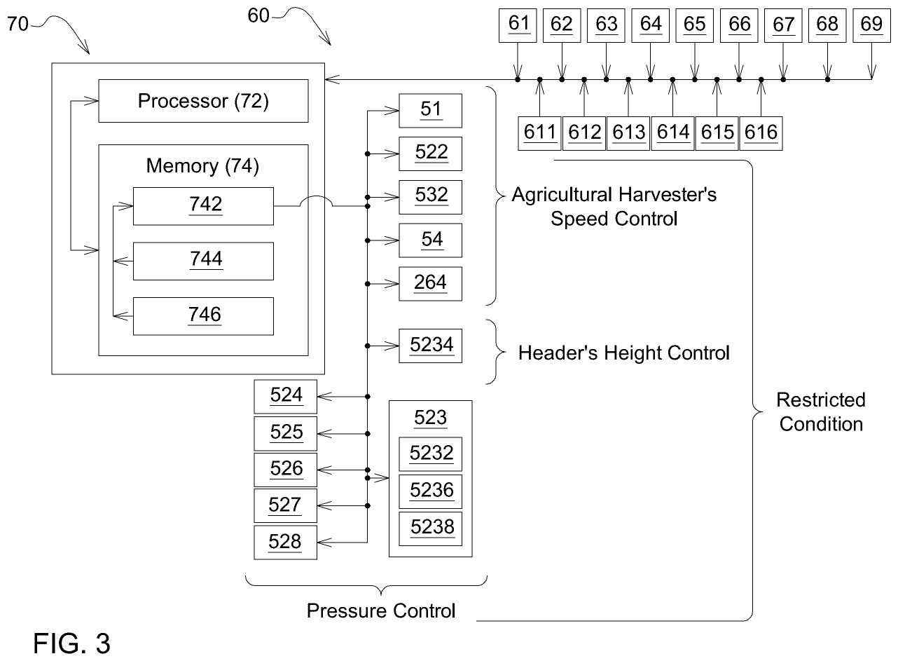

In general, the agricultural harvester 20 may include a main frame 22, an operator's station 24, a ground engaging device 26, a feederhouse 28, a header 30, and an actuator 32. The main frame 22 has a first end 222 and a second end 224 spaced from the first end 222 along a central longitudinal axis L of the main frame 22. The operator's station 24 (cab) is equipped on the main frame 22 and allows a user/operator to control the agricultural harvester 20. In another embodiment where the agricultural harvester 20 is an autonomous agricultural harvester or is controlled by a workstation remotely, the operation's station 24 may be omitted. The ground engaging device 26 is coupled to the main frame 22 and configured to support the main frame 22 relative to the ground and to move the main frame 22 in a direction V of travel during operation. The agricultural harvester 20 may be driven in the direction V of travel hydraulically, electrically, or both, and a speed of the agricultural harvester 20 may be adjusted in the restricted condition, which is described later. The ground engaging device 26 may be wheels, tracks, or a combination thereof. A brake 264 (as shown FIG. 3) may be installed on the ground engaging device 26 to decrease the speed of the agricultural harvester 20.

The header 30 is configured to cut, gather, and transport crop rearwardly to the feederhouse 28. The header 30 includes but is not limited to a draper, a corn head, a belt pickup. The belt pickup uses rubber belts to pick up cut crop. Optionally, the header 30 may also include an extendable header (e.g., an extendable auger header) or non-extendable header, depending on the need. If the extendable auger header is applied, it may extend in the forward direction to a forward position (FIG. 1C) or retract in the rearward direction to a rearward position (FIG. 1B). A table length control actuator (not shown, may be a hydraulic cylinder) is disposed in the header 30 and configured to control the length of the extendable header.

Referring to FIG. 1A, the feederhouse 28 is pivotably coupled to the main frame 22 on a pivot unit 34 and configured for attachment to the header 30. The actuator 32 is configured to pivot the feederhouse 28 on the pivot unit 34 about a pivot axis 36 to lift or lower the header 30 to an appropriate height for harvesting or transportation. The feederhouse 28 advances crop received from the header 30 into the body of the agricultural harvester 20 for further processing, such as threshing and separating.

The header 30 may be directly coupled to the feederhouse 28. However, in another implementation, as shown in FIG. 1D, the front end of the feederhouse 28 is coupled to an attachment frame 29 of the header 30, and a center frame 302 of the header 30 is pivotable relative to the attachment frame 29 about an axis 292. An actuator 321, coupled between the attachment frame 29 and the center frame 302, disposed downstream an accumulator 5258, is configured to provide the suspension between the center frame 302 and the attachment frame 29 of the header 30. Optionally, the actuator 321 is configured to pivot the center frame 302 relative to the attachment frame 29 about the axis 292. The number of the actuators 321 may be two or more.

In another implementation, as shown in FIG. 1E, the header 30 may be a foldable header and include the center frame 302, wing frames 304, 306. An actuator 322 is configured to provide the suspension between the center frame 302 and the wing frame 304. Optionally, the actuator 322 is configured to pivot the wing frame 304 relative to the center frame 302 about an axis 3022. An actuator 324 is configured to provide the suspension between the center frame 302 and the wing frame 306. Optionally, the actuator 324 is configured to pivot the wing frame 306 relative to the center frame 302 about an axis 3024.

Referring to FIGS. 1F and 1G, a tilt frame 282 is pivotably coupled to the feederhouse 28 about an axis 284 with a pivot unit (pin) in the Y-Z plane. The tilt frame 292, on the other side, is coupled with the header 30. The head 30 may also include a left wheel 36L and a right wheel 36R. The agricultural harvester 20 may include a tilt actuator 326 and a tilt actuator 328 disposed on the opposite sides of the feederhouse 28. There is an angle θ between the tilt actuator 326 and a vertical line. Similarly, there is an angle θ between the tilt actuator 328 and a vertical line. Cap ends of the tilt actuators 326, 328 may be coupled to the feederhouse 28 or other part of the body of the agricultural harvester 20, and rod ends of the tilt actuators 326, 328 may be coupled to the tilt frame 282 and are operable to pivot the tilt frame 282 relative to the feederhouse 28 or the body of the agricultural harvester 20. It is noted that the number of the tilt actuators 326, 328 illustrated in FIG. 1G is merely for demonstration purpose; in another implementation the agricultural harvester 20 may have a single or more than two tilt actuators to pivot the header 30. A twist load may happen through numerous ways. In one example, during the traveling of the agricultural harvester 20, a rock or other object may lift one of the wheels (like right wheel 36R) and generate the twist load to rotate the header 30 relative to the body of the agricultural harvester 20. In this example, when the twist load generated by the rock or other object is greater than an appropriate value, the twist load may affect the fatigue life of the feederhouse 28 or another component of the agricultural harvester 20. In another example, the extension and retraction of the tilt actuators 326, 328 will rotate the header 30 relative to the body of the agricultural harvester 20 for alignment or testing purposes, for instance. As shown in FIG. 1G, with the tilt actuator 328 retracting and the tilt actuator 328 extending, a twist load Tₕ is generated in a counterclockwise direction.

Referring to FIG. 1A, the agricultural harvester 20 may also include a threshing and separating section 40, a cleaning section 41, a clean grain elevator 42, a grain tank 43, an unloader 44, a beater 45, a chopper 46 and a spreader 47. The threshing and separating section 40 threshes crop and further separates grain from crop residue. The cleaning section 41 may include chaffers and sieves to separate grain from chaff (husks of corn or other seed) or other small pieces of crop material. The clean grain elevator 42 elevates clean grain to the grain tank 43. The unloader 44, which is rotatable, can unload clean grain from the grain tank 43 to a grain cart, a grain truck, or another location. The beater 45 beats crop residue that is received from the threshing and separating section 40 and does not pass to the cleaning section 41 (e.g., straw, stalks, cobs, leaves). The chopper 46 chops the crop residue from the threshing and separating section 40, through the beater 45, to the chopper 46. The spreader 47 is positioned rearward of the chopper 46 and is able to return the chopped residue from the chopper 46 to the field.

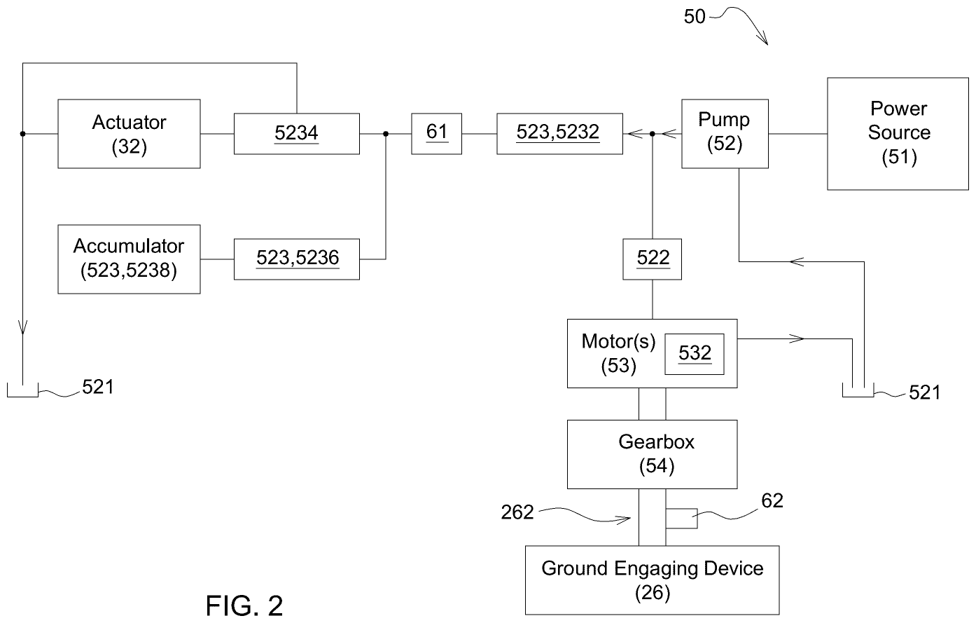

Referring to FIG. 2, the agricultural harvester 20 includes a power system 50 that determine the travel speed of the agricultural harvester 20, the movement of the actuator 32 (i.e., the height of the header 30 that is coupled to the agricultural harvester and moved by the actuator 32), and the hydraulic pressure of the actuator 32. The power system 50 includes a power source 51 and a pump 52 physically coupled to the power source 51. In one example, the power source 51 may include an engine that drives the pump 52. In another example, the power source 51 may include a battery, an inverter, and an electric motor (not shown) that drives the pump 52. The power source 51 may have different structures from the example as described above. Several components, such as belts and pulleys, are omitted in FIG. 2. The pump 52 pumps hydraulic fluid from a hydraulic tank 521 to a motor(s) 53 to drive the ground engaging device 26. The power source 51 may be adjustable to change the speed or pressure of the pump 52 so as to change the speed of the ground engaging device 26. The motor(s) 53 is/are a hydraulic motor(s) that returns the hydraulic fluid to the hydraulic tank 521. A flow control valve 522 is positioned between the pump 52 and the motor(s) 53 that regulates the hydraulic fluid entering the motor(s) 53 to change the rotational speed of the motor(s) so as to change the speed of the ground engaging device 26. A gearbox(es) 54 may be provided and coupled between the motor(s) 53 and the ground engaging device 26 through an axle 262. The gearbox(es) 54 may include multiple gears to provide multiple gear ranges to change the speed of the ground engaging device 26. The number of the motor(s) may be one, two, or more. For one implementation, when the number of the motor 53 is one, the motor 53 drives the front wheels (or front tracks). For another implementation, when the number of the motor(s) is two, one motor may drive the front wheels (or front tracks) and the other motor may drive the rear wheels (or rear tracks). The two motors may be positioned parallel to each other in the hydraulic circuit. A switch mechanism 532 may switch the operations between one-motor mode (i.e., two-wheel drive) and two-motor mode (i.e., four-wheel drive). The switch mechanism 532 may selectively permit the hydraulic fluid to enter one or two of the motors to switch the mode between the one-motor mode and the two-motor mode. The switch mechanism 532 may be a flow control valve disposed upstream one of the motors 53 to render that motor active or idle. In one-motor mode, when the switch mechanism is off, the hydraulic fluid only enters to one of the motors. In two-motor mode, when the switch mechanism 532 is on, the hydraulic fluid originally going to one motor is divided and enters two motors concurrently. The output of the originally running motor is decreased and the speed of the ground engaging device 26 is decreased. The brake 264 may be installed on the ground engaging device 26 to change the speed of the ground engaging device 26.

As discussed, there are numerous ways to change the speed of the ground engaging device 26, which corresponding the speed of the agricultural harvester 20. These include but are not limited to adjusting the output from power source 51 to drive the pump, regulating the hydraulic fluid and pressure thereof between the pump 52 and the motor(s) 53, splitting the hydraulic fluid to two or more motors 53 if the number of the motors 53 is plural, switching gear ranges in the gearbox(es) 54, and activating the brake 264 applied on the ground engaging device 26. The criteria to change the speed of the agricultural harvester 20 and the extent of the change would be described later.

The pump 52 may also pump the hydraulic fluid into the actuator 32 to lift or lower the header 30. At least one hydraulic pressure controller 523 is hydraulically connected to the actuator 32 and is configured to control a hydraulic pressure of a hydraulic fluid entering the actuator 32. For one example, the hydraulic pressure controller 523 may include a pressure regulating valve 5232 disposed upstream the actuator 32 to adjust the hydraulic pressure of the hydraulic fluid entering the actuator 32 and an accumulator 5238. A directional valve 5234 is positioned upstream the actuator 32 to determine the direction of hydraulic fluid so as to extend or retract the actuator 32. In another implementation, the pressure regulating valve 5232 and the directional valve 5234 may be replaced by a proportional valve (not shown), which controls the direction and the hydraulic pressure of the hydraulic fluid entering to the actuator 32. Additionally or alternatively, the hydraulic pressure controller 523 may include a flow control valve 5236 and the accumulator 5238 which are disposed upstream the actuator 32. The accumulator 5238 is disposed downstream the flow control valve 5236. The flow control valve 5236 may be an on-off valve configured to allow the hydraulic fluid to enter the accumulator 5238. When the flow control valve 5236 is on, the hydraulic pressure of the actuator 32 and the hydraulic pressure of the accumulator 5238 are substantially the same. The accumulator 5238 provides suspension for the actuator 32. The pressure regulating valve 5232, may be a proportional solenoid valve controlled by the controller 70 shown in FIG. 3. The pressure regulating valve 5232 may decrease the hydraulic fluid flowing into the accumulator 5238 and the actuator 32 to increase the suspension (the pressure in the accumulator 5238 decreases). The pressure regulating valve 5232 or other means (controlled by the controller 70 shown in FIG. 3) may increase the hydraulic fluid flowing into the accumulator 5238 and the actuator 32 to decrease the suspension (the pressure in the accumulator 5238 decreases). A restricted condition may include an increase in suspension such that an impact or load may be absorbed to make the header 30 still compatible with the body of the agricultural harvester 20, which will be discussed in this disclosure later.

The hydraulic circuit having the hydraulic pressure controller 523 may be applied to hydraulic circuits having actuators and accumulators for suspension purpose. For example, as shown in FIG. 1D, a hydraulic pressure controller 525 coupled to the power source 51 or the pump 52 may include a pressure regulating valve 5252 and the accumulator 5258 which are disposed upstream the actuator 321. The pressure regulating valve 5252 or other means (controlled by the controller 70 shown in FIG. 3) may decrease the hydraulic fluid flowing into the accumulator 5258 and the actuator 321 to increase the suspension (the pressure in the accumulator 5258 decreases). On the country, the pressure regulating valve 5252 or other means (controlled by the controller 70 shown in FIG. 3) may increase the hydraulic fluid flowing into the accumulator 5258 and the actuator 321 to decrease the suspension (the pressure in the accumulator 5258 increases). For another example, as shown in FIG. 1E, a hydraulic pressure controller 524 coupled to the power source 51 or the pump 52 may include a pressure regulating valve 5242 and the accumulator 5248 which are disposed upstream the actuator 322. The pressure regulating valve 5242 or other means (controlled by the controller 70 shown in FIG. 3) may decrease the hydraulic fluid flowing into the accumulator 5248 and the actuator 322 to increase the suspension (the pressure in the accumulator 5248 decreases). On the country, the pressure regulating valve 5242 or other means (controlled by the controller 70 shown in FIG. 3) may increase the hydraulic fluid flowing into the accumulator 5248 and the actuator 322 to decrease the suspension (the pressure in the accumulator 5248 increases). Similarly, a hydraulic pressure controller 526 coupled to the power source 51 or the pump 52 may include a pressure regulating valve 5262 and an accumulator 5268 which are disposed upstream the actuator 324. The pressure regulating valve 5262 or other means (controlled by the controller 70 shown in FIG. 3) may decrease the hydraulic fluid flowing into the accumulator 5268 and the actuator 324 to increase the suspension (the pressure in the accumulator 5268 decreases). On the contrary, the pressure regulating valve 5262 or other means (controlled by the controller 70 shown in FIG. 3) may increase the hydraulic fluid flowing into the accumulator 5268 and the actuator 324 to decrease the suspension (the pressure in the accumulator 5268 increases). For another example, as shown in FIG. 1G, a hydraulic pressure controller 527 coupled to the power source 51 or the pump 52 may include a pressure regulating valve 5272 and the accumulator 5278 which are disposed upstream the tilt actuator 326. The pressure regulating valve 5272 or other means (controlled by the controller 70 shown in FIG. 3) may decrease the hydraulic fluid flowing into the accumulator 5278 and the tilt actuator 326 to increase the suspension (the pressure in the accumulator 5248 decreases). On the country, the pressure regulating valve 5272 or other means (controlled by the controller 70 shown in FIG. 3) may increase the hydraulic fluid flowing into the accumulator 5278 and the tilt actuator 326 to decrease the suspension (the pressure in the accumulator 5278 increases). Similarly, a hydraulic pressure controller 528 coupled to the power source 51 or the pump 52 may include a pressure regulating valve 5282 and an accumulator 5288 which are disposed upstream the tilt actuator 328. The pressure regulating valve 5282 or other means (controlled by the controller 70 shown in FIG. 3) may decrease the hydraulic fluid flowing into the accumulator 5288 and the tilt actuator 328 to increase the suspension (the pressure in the accumulator 5288 decreases). On the contrary, the pressure regulating valve 5282 or other means (controlled by the controller 70 shown in FIG. 3) may increase the hydraulic fluid flowing into the accumulator 5288 and the tilt actuator 328 to decrease the suspension (the pressure in the accumulator 5288 increases).

Referring to FIG. 3, the agricultural harvester 20 may include a header compatibility control system 60 to decide whether the header 30 is compatible to the body of the agricultural harvester 20, whether, if the header 30 is compatible, the agricultural harvester 20 needs to (or is suggested to) operate in the restricted condition to decrease occurrences of the values of the load on the agricultural harvester 20, and actions in the restricted condition. The header compatibility control system 60 may include the multiple sensors 61-67, 611-616, for example, to detect characteristics of certain components or operation of the agricultural harvester 20, to detect the environment around the agricultural harvester 20, and/or to detect the identifier of the header 30. The header compatibility control system 60 may include an electronic component 68 positioned on the header 30 and configured to provide identification data and/or configuration data of the header 30. The electronic component 68, for an example, is a controller with its own memory. The header compatibility control system 60 may also include an input device 69, positioned within the operator's station 24 (FIG. 1A) or remotely from the operator's station 24. The input device 69 may include but is not limited to a touch screen and a handheld device. The header compatibility control system 60 may include a controller 70 having a processor 72 and a memory 74. The sensor 61 is configured to measure a characteristic of the agricultural harvester 20 and to generate a signal(s) indicative of the characteristic for the processor 72 to calculate the load through a lookup table or a converting algorithm stored in the memory 74. For one example, the sensor 61 (FIG. 2) is used for load detection and is positioned on or near the actuator 32. The sensor 61 is a transducer configured to measure a hydraulic pressure of the actuator 32 (lift cylinder) for the processor 72 to calculate the load of the header 30 applied to the body of the agricultural harvester 20. The sensor 61 may measure the static lift pressure for lifting the header 30 when the header 30 is just coupled to the feederhouse 28 of the agricultural harvester 20. The sensor 61 may also measure the dynamic lift pressure when the agricultural harvester 20, with the header 30, travels on the field. The dynamic lift pressure may change due to the speed of the agricultural harvester 20, the uneven terrain of the field, the reaction from the crop during harvesting, etc. The load of the header 30 results from the weight of the header 30 and a reaction from the crop material engaged with the header 30, the dynamic energy of the agricultural harvester 20 (the speed of the agricultural harvester 20), and the interaction between the agricultural harvester 20 and the environment, such as the terrain of the ground. The high peaks or spikes of the dynamic lift pressure may be measured by the sensor 61, and the high peaks or spikes of the load may be calculated by the processor 72. Additionally or alternatively, in another example, the sensor 61 may be a strain sensor attached to the feederhouse 28 or a connection kit in front of the feederhouse 28 measuring the strain and transmitting signals indicative of the strain for the processor 72 to calculate the load of the header 30. The sensor 61 may be other types of sensors, included but not limited to axial load Poisson bridge and gauged pin, configured to measure another characteristic of the header 30, the feederhouse 28, or other components of the agricultural harvester 20 and to generate signals indicative of the characteristic. The controller 70 may calculate the load through the signals from the sensor 61.

Similarly, the sensor 62 is used for measuring a characteristic of the agricultural harvester 20 but is positioned on the location different from the sensor 61. The sensor 62 is configured to measure a characteristic of the agricultural harvester 20 and to generate signals indicative of the characteristic for the processor 72 to calculate the load through a lookup table or a converting algorithm stored in the memory 74. For one example, the sensor 62 may be a strain sensor attached to the axle 262, which is coupled between the gearbox(es) 54/motor(s) 53 and the ground engaging device 26 and measuring the strain of the axle 262. In one implementation, the sensor 62 is coupled to a front axle of the axle 262 to measure a strain of the front axle. The controller 70 may calculate the load at least derived from the load of the header 30 and the load of the grain tank 43. It is noted that the load of the grain tank may vary, depending on the accumulation of the grain in the grain tank 43.

The sensor 63 may be a position sensor configured to measure a position of the feederhouse 28 (or header 30) and to transmit signals indicative of the position of the feederhouse 28 (or header 30) to the controller 70. In one example, the sensor 63 may be an angular position sensor, such as a potentiometer, positioned on the pivot unit 34 and measuring the angle of the pivot unit 34, and the processor 72, after receives the signals from the sensor 63, calculates the position of the feederhouse 28. In another example, the sensor 63 may be a displacement sensor positioned on the actuator 32 and is configured to measure the displacement (e.g., the extension or retraction) of the actuator 32, and the processor 72, after receives the signals from the sensor 63, calculates the position of the feederhouse 28. The type and the location of the sensor 63 described herein are examples. Another type and another location of the sensor 63 in different implementations may be used to measure the position of the feederhouse 28. The memory 74 of the controller 70 may include pre-stored configuration data regarding the combination of the header 30 and the feederhouse 28. For example, the location of the center of mass of the header 30 may be saved in the memory 74. The processor 72 may calculate the moment arm based on the position of the feederhouse 28 and the pre-stored configuration data (e.g., the location of the center of mass CM of the header 30, the angular position of the feederhouse 28, the width and weight of the header 30, distance between the cutter of the header 30 and the pivot unit 34 (pivot axis 36), the length of the feederhouse 28, etc.). For an example only, the moment arm may be a distance between the center of the mass CM and the pivot axis 36 multiple a cosine angle between the feederhouse 28 and a horizontal plane. The load of the header 30 and the position of the feederhouse 28 (or header 30) are recorded in the memory 74. The processor 72 may also calculate the moment based on the signals from at the sensors 61,63 and the pre-stored configuration data.

The sensors 64, 65 described here are examples of operation sensors configured to detect the operational parameters of the agricultural harvester 20 and transmit signals indicative of the operational parameters to the controller 70. It is noted that sensors 61-63 may be counted as operation sensors. The controller 70 may classify the state of the agricultural harvester 20, which is discussed later. The operation state of the agricultural harvester 20 may include but is not limited to traveling parallel to rows or angled to rows, brake assisted turns, field transport, field exits, field broader crossing, and road transport. The rows here may refer to the row of crop. In some operations, the agriculture harvester 20 travels on the ground of the field which is uneven. For example, when the agriculture harvester performs border crossing (levee crossing) in the field, the border (e.g., levee) area is an uneven ground, which causes a higher load from the header to the agricultural harvester.

The sensor 64 may be a speed sensor configured to measure the speed of the agricultural harvester 20. The sensor 65 may include a vibration sensor or an accelerometer that senses vibration or acceleration of the agricultural harvester 20. The sensor 66 may be an image sensor i.e., camera, configured to capture images of the ground in front of the agricultural harvester 20 and to transmit signals indicative of the images of the ground to the controller 70. The sensor 67 may be a scanner, a reader (e.g., RFID chip reader), or other type of sensor. When the header 30 is hooked on the body of the agricultural harvester 20, the sensor 67 may read or retrieve the identification data from the header 30 and transmit a signal indicative of the identity of the header 30. After the type of the header 30 is identified, the controller 70 may retrieve the configuration data (e.g., the weight, center of mass, machine moment of inertia) of the header 30 from the memory 74 or other sources to process. Additionally or alternatively, when the header 30 is hooked on the body of the agricultural harvester 20, an electronic component 68 (e.g., header controller, header memory) of the header 30 may be electronically connected to the controller 70 to upload the identification data, and/or configuration data (e.g., the weight, center of mass, machine moment of inertia) for the controller 70 to process. An input device 69 is coupled to the controller 70 and configured to transmit signals indicative of inputs to the controller 70. The operator can input various information, commands, or preferences into the user interface of the input device 69. In one example, the operator may command the actuator 32 to raise or lower the header 30 through the input device 69. In another example, the operator may input a travel path of the agricultural harvester 20 through the input device 69. In another example, the operator may input the configuration data of header 30 or select the model of the header 30 through the input device 69.

It is noted that the sensors 61 or 62 may include sensors 611-616 operable to measure the load or hydraulic pressure of hydraulic cylinders or other components. Similar to the description of the sensor 61, the sensor 611 may be a transducer configured to measure a hydraulic pressure in the actuator 321 (FIG. 1D) for the processor 72 to determine an appropriate value of hydraulic pressure corresponding to suspension. The sensors 612, 613 may be transducer configured to measure hydraulic pressures in the actuators 322, 324 (FIG. 1E) for the processor 72 to determine appropriate values of hydraulic pressures. The sensors 614, 615 may be transducers configured to measure hydraulic pressures in the tilt actuators 326, 328 (FIG. 1G) for the processor 72 to calculate the twist load and to determine appropriate values of hydraulic pressures. The sensors 611-615 may be other types of sensors, included but not limited to axial load Poisson bridge and gauged pin, and load cell, configured to measure another characteristic of the actuators 321, 322, 324, 326, 328. The sensor 616 (FIG. 1G) may be coupled to the pivot unit (pin) defining the axis 284 and configured to measure the twist load. The sensors 616 may include types of sensors, included but not limited to tortional bridge and gauged pin.

When the sensor 65 includes the accelerometer, the sensor 65 may also include a gravity sensor. The accelerometer and the gravity sensor may be used to determine whether the agricultural harvester 20 is positioned on the horizontal ground.

Referring to FIG. 3, the controller 70 is disposed in communication with the sensors 61-67, 611-616, the electronic component 68, the input device 69 and the outputs, including but not limited to the power source 51, the flow control valve 522, the switch mechanism 532, the gearbox(es) 54, the brake 264, the directional valve 5234, the hydraulic pressure controller 523 (e.g., the pressure regulating valve 5232 and/or flow control valve 5236 and accumulator 5238), and the hydraulic pressure controllers 524, 525, 526, 527, 528. The controller 70 is operable to receive signals indicative of the characteristic (e.g., hydraulic pressure, strain) from the sensor 61 to determine the load of the header 30, signals indicative of the characteristic (e.g., hydraulic pressure, strain) from the sensor 611 to determine the load or hydraulic pressure of the actuator 321, signals indicative of the characteristic (e.g., hydraulic pressure, strain) from the sensors 612, 613 to determine the load or hydraulic pressure of the actuators 322, 324, signals indicative of the characteristic (e.g., hydraulic pressure, strain) from the sensors 614, 615 to determine the twist load or hydraulic pressure of the tilt actuator 326, 328, signals indicative of the characteristic (e.g., strain) from the sensor 616 to determine the twist load on the pivot unit (pin) that defining the axis 284, signals indicative of the characteristic (e.g., strain) from the sensor 62 to determine the load of the axle, signals indicative of the position of the feederhouse 28 from the sensor 63, signals indicative of the speed of the agricultural harvester 20 from the sensor 64, signals indicative of the vibration (or acceleration) of the agricultural harvester 20 from sensor 65, signals indicative of the images of the ground from the sensor 66, a signal indicative of the identity of the header 30 from the sensor 67, signals indicative of the identification data and/or configuration data from the electronic component 68, signals from input device 69 and communicate signals to the output including but not limited to the power source 51, the flow control valve 522, the switch mechanism 532, the gearbox(es) 54, the brake 264, the directional valve 5234, and the hydraulic pressure controller 523-527. While the controller 70 is generally described herein as a singular device, it should be appreciated that the controller 70 may include multiple devices linked together to share and/or communicate information therebetween. Furthermore, it should be appreciated that the controller 70 may be located on the agricultural harvester 20 or located remotely from the agricultural harvester 20.

The controller 70 may alternatively be referred to as a computer, a computing device, a control unit, a control module, a module, etc. The controller 70 includes the processor 72, the memory 74, and all software, hardware, algorithms, connections, sensors, etc., necessary to manage and control the operation of the sensors 61-67, 611-616, the electronic component 68, the input device 69 and the outputs including but not limited to the power source 51, the flow control valve 522, the switch mechanism 532, the gearbox(es) 54, the brake 264, the directional valve 5234, and the hydraulic pressure controllers 523-527. As such, a method may be embodied as a program or algorithm operable on the controller 70. It should be appreciated that the controller 70 may include any device capable of analyzing data from various sensors, comparing data, making decisions, and executing the required tasks.

As used herein, “controller 70” is intended to be used consistent with how the term is used by a person of skill in the art, and refers to a computing component with processing, memory, and communication capabilities, which is utilized to execute instructions (i.e., stored on the memory or received via the communication capabilities) to control or communicate with one or more other components. In certain embodiments, the controller 70 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The controller 70 may be in communication with other components on the agricultural harvester 20, such as hydraulic components, other electrical components, and operator inputs within an operator's station of an associated work vehicle. The controller 70 may be electrically connected to these other components by a wiring harness such that messages, commands, and electrical power may be transmitted between the controller 70 and the other components. Although the controller 70 is referenced in the singular, in alternative embodiments the configuration and functionality described herein can be split across multiple devices using techniques known to a person of ordinary skill in the art.

The controller 70 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. The memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The controller 70 includes the tangible, non-transitory memory 74 on which are recorded computer-executable instructions, including a compatibility control algorithm 742, an operation state classifier algorithm 744, and another algorithm 746. The processor 72 of the controller 70 is configured for executing the compatibility control algorithm 742. The compatibility control algorithm 742 implements methods of a compatibility control of agricultural harvester 20, described in detail below.

In the first implementation, the processor 72 compares the moment with moment threshold(s) to proceed. The processor 72 is operable to execute the compatibility control algorithm 742 to receive the signals indicative of the characteristic (e.g., hydraulic pressure of the actuator 32 or strain of the axle 262) from the sensor 61 and/or sensor 62 to determine the load of the agricultural harvester 20. The signals from the sensor 61 are used to determine the load of the header 30 and the signals from the sensor 62 are used to determine the load of the axle 262, for example. The load may be determined by the processor 72 executing the compatibility control algorithm 742 or another algorithm 746 using the correlation between the measured characteristic and the load. The moment on the header 30 and the moment on the axle 262 are converted from the load via the processor 72. As discussed, the processor 72, after receives the signals from the sensor 63, calculates the position of the feederhouse 28 so as to obtain the moment arm, which may be used for the moment conversion. The processor 72 may calculate the moment based on the signals from the sensor 61 and the signals from the sensor 63. As to the moment on the axle 262, the processor 72 may utilize a pre-determined reference point as a fulcrum and converted the load measured indirectly or directly from the sensor 62 to the moment on the axle 262. The more frequent the high moments occurs within a specific time frame, the shorter fatigue life of the structural components of the agricultural harvester 20.

The processor 72 is operable to determine, based on the signal(s) indicative of the characteristic, whether the moment is equal to or greater than a first (moment) threshold. If the moment is equal to or greater than the first threshold, the restricted condition may be calculated and performed to make the relative heavy header 30 compatible. If the moment is less than the first threshold, the restricted condition is not needed. Optionally, processor 72 is operable to execute the compatibility control algorithm 742 to determine, based on the signal, whether the moment is equal to or less than a second (moment) threshold, which is stored in the memory 74. Even if the moment is determined to be equal to or greater than the first threshold, the restricted condition may not be calculated and performed unless moment is equal to or less than the second threshold. When the moment is greater than the second threshold, the header 30 may still not be compatible with the body of the agricultural harvester 20 even if the restricted condition is performed.

The processor 72 is operable to calculate, if the moment is determined to be equal to or greater than the first threshold, the restricted condition based on the moment, and control the agricultural harvester 20 to operate in the restricted condition to decrease occurrences of the values of the load in response to the moment being equal to or greater than the first threshold. There are various methods in the restricted condition to decrease occurrences of the values of the load: the controller 70 may (1) reduce the speed of the agricultural harvester 20 to or below a pre-determined speed, (2) lower the height of the header relative to the ground equal to or below a pre-determined height, (3) restrict the hydraulic pressure to or under a pre-determined first hydraulic pressure value to increase the suspension, and/or (4) retract the header 30 if the header 30 is extendable (retractable), etc. Those methods (1)-(4) may be used alone or together with others. As discussed previously, the components of the agricultural harvester 20 may be performed to reduce the speed of the agricultural harvester 20, to lower the height of the header, to restrict the hydraulic pressure of the actuators 32, 321, 322, 324, 326, 328 and accumulators 5248, 5258, 5268, etc., and/or to change the length of the header if it is extendable. The processor 72 is operable to calculate the restricted condition based on the moment, with a lookup table saved in the memory 74 comprising different values of moment corresponding to respective pre-determined speeds, respective pre-determined heights, respective pre-determined first hydraulic pressure values (or corresponding values of suspension) and/or respective length of the header 30 (if the header 30 is extendable).

Regarding reducing the speed of the agricultural harvester 20 in the restricted condition, the processor 72 is operable to execute the compatibility control algorithm 742 to downshift gears of the gearbox(es) 54 of the agricultural harvester 20 and/or initiate the brake 264 of the ground engaging device 26 to reduce the speed of the agricultural harvester 20 to or below a pre-determined speed. The pre-determined speed may be stored in the memory 74, as a value in the lookup table. Additionally or alternatively, the in the restricted condition, the processor 72 is operable to execute the compatibility control algorithm 742 to decrease an output of the motor(s) 53 of the agricultural harvester 20 to reduce the speed of the agricultural harvester 20 to or below a pre-determined speed. The pre-determined speed (or the output of the motor(s) 53) may also be stored in the memory 74, as a value in the lookup table. For example, the processor 72 may decrease the output from the power source 51 (e.g., the engine or the electric motor, not shown). In another example, the processor 72 may adjust the flow control valve 522 to decrease the hydraulic fluid entering the motor(s) 53 to reduce the speed of the motor(s) 53. In another example, the processor 72 may control the switch mechanism 532 to switch the mode of the motors 53, when the number of the motors 53 is plural, from the one-motor mode and two-motor mode to decrease the speed of the originally running motor 53. The generic principles defined herein may be applied to other examples without departing from the scope of the disclosure.

Regarding lowering the height of the header 30 in the restricted condition, in one example, the processor 72 is operable to execute the compatibility control algorithm 742 to extend or retract the actuator 32 to lower a height of the header 30 relative to the ground equal to or below a pre-determined height, which may be stored in the memory 74, as a value in the lookup table. In one example, the processor 72 may control the directional valve 5234 to adjust the displacement of the actuator 32 to change the height of the header 30. As a result, the moment arm of the header 30 becomes shorter when the header 30 moves to a lower position. The generic principles defined herein may be applied to other examples without departing from the scope of the disclosure.

Rather than adjusting the height of the header 30 (height-based control), the processor 72 is operable to execute the compatibility control algorithm 742 to activate the hydraulic pressure controller 523 to restrict the hydraulic pressure to be equal to or less than a first hydraulic pressure value. For one example, the processor 72 is operable to execute the compatibility control algorithm 742 to control the pressure regulating valve 5232 disposed upstream the actuator 32 to adjust the hydraulic pressure of the fluid entering the actuator 32. In another example, the processor 72 is operable to execute the compatibility control algorithm 742 to open the flow control valve 5236 to restrict the hydraulic pressure of the actuator 32 to be equal to a first hydraulic pressure of the accumulator 5238. The flow control valve 5236 is optional and the processor 72 is operable to execute the compatibility control algorithm 742 to control the pressure regulating valve 5232 to adjust the hydraulic pressure of the fluid entering the actuator 32 and the accumulator 5238. As such, the processor 72 can increase the suspension of the hydraulic circuit have the actuator 32 and the accumulator in the restricted condition. When the hydraulic pressure is held constant in the restricted condition, the pressure-based control will restrict the load of the header 30 within a proper range. The generic principles defined herein may be applied to other examples without departing from the scope of the disclosure.

Similarly, the processor 72 may execute the compatibility control algorithm 742 to control at least one of the pressure regulating valves 5242 (FIG. 1E), 5252 (FIG. 1D), 5262 (FIG. 1E), 5272 (FIG. 1G), 5282 (FIG. 1G) to decrease the hydraulic pressure in the at least one of actuators 32, 321, 322, 324, 326, or 328 and accumulators 5248, 5258, 5286, etc. to increase suspension in the restricted condition.

Regarding retracting the header 30 in the restricted condition, if the header 30 is the extendable head, the processor 72 is operable to execute the compatibility control algorithm 742 to drive the table length control actuator (not shown) to decrease the length of the header 30 to a pre-determined length of the header 30. The pre-determined length may be stored in the memory 74, as a value in the lookup table. For example, as shown in FIGS. 1B and 1C, the center of mass CM may move from the forward position (FIG. 1B) to the rearward position (FIG. 1C). The moment arm will be shorter with location of the center of mass CM moving to the rearward direction. The generic principles defined herein may be applied to other examples without departing from the scope of the disclosure.

It is noted that in addition to the measurement of the load or moment, the controller 70 may receive other inputs to determine or calculate the restricted condition for the agricultural harvester 20. For instance, the controller 70 receives signals indicative of the input from the input device 69 and signal indicative of the operation parameter(s) generated by the operation sensor(s), such as the sensors 63, 64 or other sensors in this disclosure. The processor 72 is operable to execute the operation state classifier algorithm 744 (FIG. 3) to classify an operation state derived from the signal indicative of the input and the signal indicative of the operational parameter and to execute the compatibility control algorithm 742 to calculate the restricted condition based on the operation state. In one example, when operator selects to end the harvesting mode and separator mode through the input device 69, the sensor 63 detects the position of the header 30 is above a certain height, and the sensor 64 detects the travel speed of the agricultural harvester 20 is above a certain value, like 8 miles per hour, the inputs will be calculated by the controller 70. The processor 72 is operable to execute the operation state classifier algorithm 744 to classify the state as field transport state, based on the input from the input device 69 and the input from the sensors 63, 64. After the field transport state is classified or determined, the processor 72 is operable to execute compatibility control algorithm 742 to calculates the restricted condition, with other input(s) such as the load, moment, the current position of the header 30, the current speed of the agricultural harvester 20, etc. In another example, when operator selects the harvesting mode, the position of the header 30 detected by the sensor 62 is commonly used for harvesting, and the sensor 65 detects more frequent vibration or acceleration, the processor 72 is operable to execute the operation state classifier algorithm 744 to classify the state as angled to (crop) rows state. Additionally or alternatively, another operation sensor (not shown) may detect rotational speed of a component of the agricultural harvester 20, such as a shaft that drives the operation of the header 30 and transmits a signal indicative of the rotational speed to the processor 72 to execute the operation state classifier algorithm 744 to classify the state. After the angled to (crop) rows state is classified or determined, the processor 72 is operable to execute compatibility control algorithm 742 to calculates the restricted condition, with other inputs, such as the load or the moment. The operation state includes but not limited to harvesting parallel to rows, angled to rows, brake assisted turns, field transport, field exits, road transport, and field border crossing, which are defined in the operation state classifier algorithm.

Additionally or alternatively, for another instance to calculate the restricted condition, the controller 70 receives signal(s) indicative of the image(s) from the sensor 66. The processor 72 is operable to execute the compatibility control algorithm 742 to calculate the restricted condition based on the signal indicative of the image, with other inputs such as the load or the moment, the speed of the agricultural harvester. The processor 72 may determine what type of terrain in front of the agricultural harvester 20, such as the number of the bumps, the sizes of the bumps, the hill, the ditch, etc. If a huge bump, such as a levee, is in front of the agricultural harvester 20 and the image of which is captured by the sensor 66, the processor 72, for example, may determine the restricted condition including to reduce the speed of the agricultural harvester 20, to lower the header 30, and/or to restrict the hydraulic pressure on the actuator 32.

Additionally or alternatively, for another instance to calculate the restricted condition, the controller 70 receives signal(s) indicative of the input(s) from the input device 69 configured to input the travel path of the agricultural harvester 20. The memory 74 may stores a topographic map covering the field where the agricultural harvester 20 operates. The processor 72 is operable to execute the compatibility control algorithm 742 to extract the data of the topographic map to the travel path to obtain the data of the topographic feature along the travel path and to calculate the restricted condition based on the data of the topographic feature, with other inputs. The topographic feature may include at least one of the sizes of bumps, the distances between the bumps, the slope along the travel path, the rate of the change of the slope, and the hardness of the soil, etc. The processor is operable to execute the compatibility control algorithm to calculate the restricted condition based on at least one of the sizes of bumps, the distances between the bumps, the slope along the travel path, the rate of the change of the slope, and the hardness of the soil, etc.

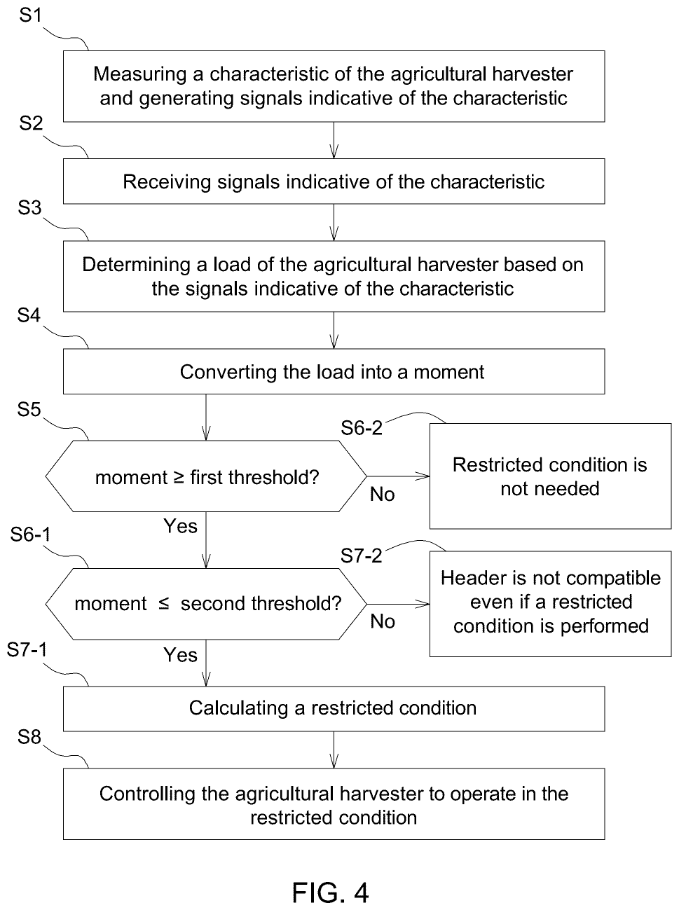

Referring to FIG. 4, a method of compatibility control of the agricultural harvester 20 briefly corresponding to the first implementation is illustrated.

S1: Measuring a characteristic of the agricultural harvester and generating signals indicative of the characteristic.

S2: Receiving signals indicative of the characteristic.

S3: Determining a load of the agricultural harvester based on the signals indicative of the characteristic.

S4: Converting the load into a moment.

S5: Comparing the moment with a first threshold. If the moment is equal to or greater than the first threshold, go to S6-1; if the moment is less than the first threshold, go to S6-2.

S6-1: Comparing the moment with a second threshold. If the moment is equal to or less than the second threshold, go to S7-1; if the moment is greater than the second threshold, go to S7-2.

S6-2: The moment less than the first threshold indicates a restricted condition is not needed. A display may notify this information to the operator.

S7-1: Calculating a restricted condition. Optionally, the display may notify the content of the restricted condition to the operator and request the operator's approval on the restricted condition.

S7-2: The moment greater than the second threshold indicates the header is not compatible even if the restricted condition is performed. The display may notify this information to the operator.

S8: Controlling the agricultural harvester to operate in the restricted condition.

In the second implementation, the processor 72 utilizes the load to proceed. The processor 72 is operable to execute the compatibility control algorithm 742 to receive the signals indicative of the characteristic from the sensor 61 and/or sensor 62 to determine the load of the agricultural harvester 20, as described in the first implementation. The load may be determined by the processor 72 executing the compatibility control algorithm 742 or another algorithm 746 using the correlation between the measured characteristic and the load. Unlike the first implementation, in the second implementation, the load is not converted into the moment for comparison. The more frequent the high load occurs within a specific time frame, the shorter fatigue life of the structural components of the agricultural harvester 20.

The processor 72 is operable to determine, based on the indicative of the characteristic, whether the load is equal to or greater than a first (load) threshold. If the load is equal to or greater than the first (load) threshold, the restricted condition may be calculated and performed to make the relative heavy header 30 compatible. If the load is less than the first (load) threshold, the restricted condition is not needed. Optionally, processor 72 is operable to execute the compatibility control algorithm 742 to determine, based on the signal, whether the load is equal to or less than a second (load) threshold, which is stored in the memory 74. Even if the load is determined to be equal to or greater than the first threshold, the restricted condition may not be calculated and performed unless load is equal to or less than the second threshold. When the load is greater than the second threshold, the header 30 may still not be compatible with the body of the agricultural harvester 20 even if a restricted condition is performed.

The processor 72 is operable to calculate, if the load is determined to be equal to or greater than the first threshold, the restricted condition based on the load, and control the agricultural harvester 20 to operate in the restricted condition to decrease occurrences of the values of the load in response to the load being equal to or greater than the first threshold. There are various methods in the restricted condition to decrease occurrences of the values of the load: the controller 70 may (1) reduce the speed of the agricultural harvester 20 to or below a pre-determined speed, (2) lower the height of the header relative to the ground equal to or below a pre-determined height, (3) restrict the hydraulic pressure to or under a pre-determined first hydraulic pressure value, and/or (4) retract the header 30 if the header 30 is extendable (retractable), etc. Like the first implementation, those methods (1)-(4) may be used alone or together with others. As discussed previously, the components of the agricultural harvester 20 may be performed to reduce the speed of the agricultural harvester 20, to lower the height of the header, to restrict the hydraulic pressure of the actuator 32, and/or to change the length of the header if it is extendable. The processor is operable to calculate the restricted condition based on the load, with a lookup table saved in the memory 74 comprising different values of load corresponding to respective pre-determined speeds, respective pre-determined heights, respective pre-determined first hydraulic pressure values and/or respective lengths of the header 30 (if the header 30 is extendable). The various inputs (sensors 61-67, and input device 69) to the processor 72 for the restricted condition calculation are similar to the inputs as discussed in the first implementation.

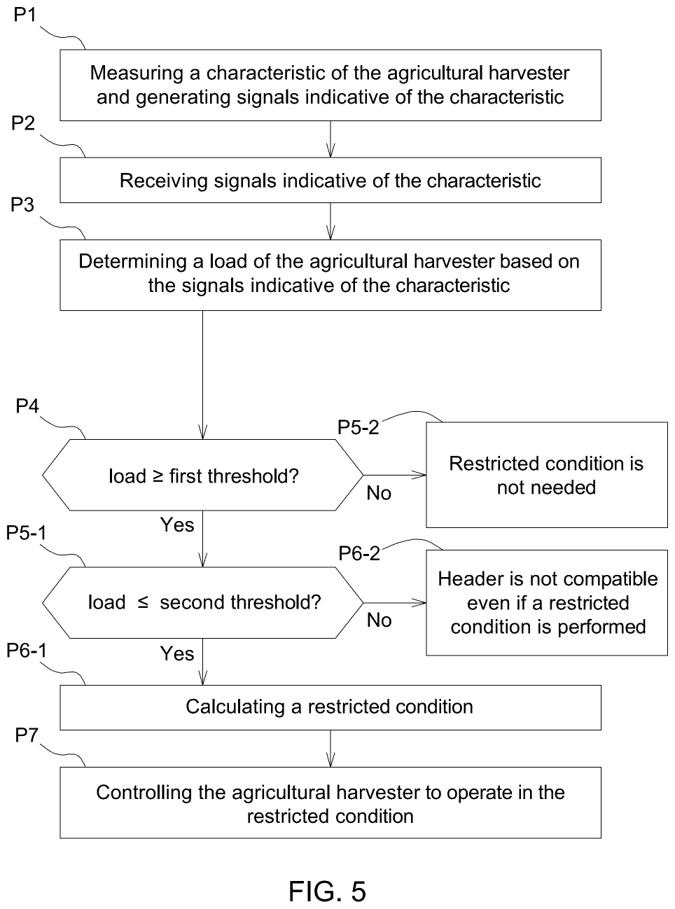

Referring to FIG. 5, a method of compatibility control of the agricultural harvester 20 briefly corresponding to the second implementation is illustrated.

P1: Measuring a characteristic of the agricultural harvester and generating signals indicative of the characteristic.

P2: Receiving signals indicative of the characteristic.

P3: Determining a load of the agricultural harvester based on the signals indicative of the characteristic.

P4: Comparing the load with a first threshold. If the load is equal to or greater than the first threshold, go to P5-1; if the load is less than the first threshold, go to P5-2

P5-1: Comparing the load with a second threshold. If the load is equal to or less than the second threshold, go to P6-1; if the load is greater than the second threshold, go to P6-2.

P5-2: The load less than the first threshold indicates a restricted condition is not needed. A display may notify this information to the operator.

P6-1: Calculating a restricted condition. Optionally, the display may notify the content of the restricted condition to the operator and request the operator's approval on the restricted condition.

P6-2: The load greater than the second threshold indicates the header is not compatible even if a restricted condition is performed. The display may notify this information to the operator.

P7: Controlling the agricultural harvester to operate in the restricted condition.

In the third implementation, the processor 72 utilizes the configuration data of the header 30 to calculate the restricted condition. In one example, when the header 30 is hooked on the body of the agricultural harvester 20, the sensor 67 may read or retrieve the identification data from the header 30 and transmit a signal indicative of the identity of the header 30 to the controller 70 to identify the header 30. After the type of the header 30 is identified, the controller 70 may retrieve the configuration data of the header 30 from the memory 74 or other sources (e.g., internet, cloud, etc.). The processor 72 compares values of the configuration data, such as weight and/or size of the header 30, with the reference value(s) pre-stored in the memory 74 to determine whether to calculate the restricted condition. The processor 72 is operable to determine, based on the configuration data, whether the values of the configuration data is equal to or greater than a first reference value (such as a weight and/or size threshold). If values of the configuration data is equal to or greater than a first reference value, the restricted condition may be calculated and performed to make the relative heavy header 30 compatible. If the values of the configuration data is less than the first reference value, the restricted condition is not needed. In another example, when the header 30 is hooked on the body of the agricultural harvester 20, the electronic component 68 may be electronically connected to the controller 70 to upload the configuration data to the controller 70. Like previous example in this paragraph, the processor 72 compares values of the configuration data, such as weight and/or size of the header 30, with the reference value(s) pre-stored in the memory 74 to determine whether to calculate the restricted condition to make the relative heavy header 30 compatible.

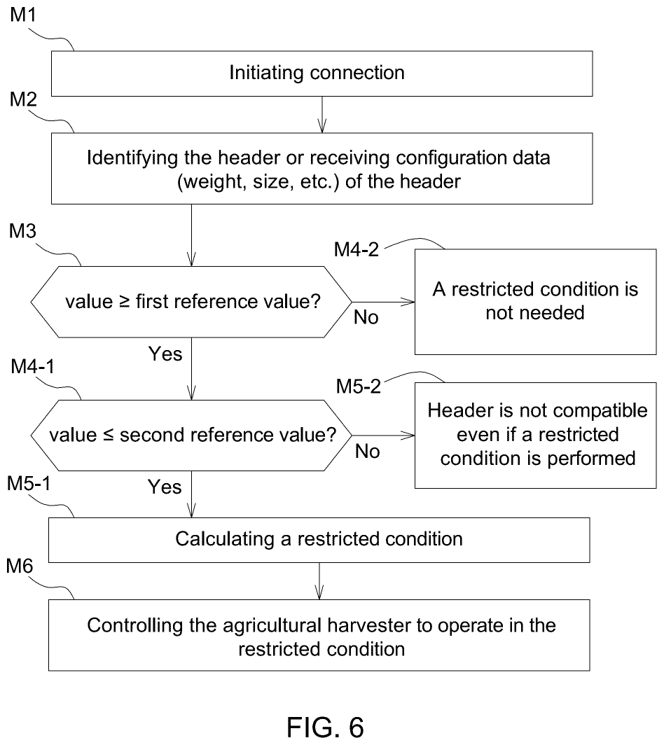

Referring to FIG. 6, a method of compatibility control of the agricultural harvester 20 briefly corresponding to the third implementation is illustrated.

M1: Initiating connection between the header and the body of the agricultural harvester.

M2: Identifying the header or receiving configuration data (weight, size, etc.) of the header.

M3: Comparing a value of the configuration data with a first reference value. If the value is equal to or greater than the first reference value, go to M4-1; if the value is less than the first reference value, go to M4-2.

M4-1: Comparing the value of the configuration data with a second reference value. If the value is equal to or less than the second reference value, go to M5-1; if the value is greater than the second reference value, go to M5-2.

M4-2: The value less than the first reference value indicates a restricted condition is not needed. A display may notify this information to the operator.

M5-1: Calculating a restricted condition. Optionally, the display may notify the content of the restricted condition to the operator and request the operator's approval on the restricted condition.

M5-2: The value greater than the second reference value indicates the header is not compatible even if a restricted condition is performed. The display may notify this information to the operator.

M6: Controlling the agricultural harvester to operate in the restricted condition.

The fourth implementation may be a combination of the first embodiment and the third embodiment or a combination of the second embodiment and the third embodiment. For example, the processor 72 utilizes the configuration data of the header 30 from the electronic component 68 or the identification data from the header 30 to calculate the restricted condition when the header is just engaged with the body of the agricultural harvester 20, as described in the third implementation. During the operation of agricultural harvester 20, the controller 70 may calculate and update the restricted condition, based on the moment (first implementation) and/or the load (second implementation), and inputs from the sensors 61-67 and the input device 69.

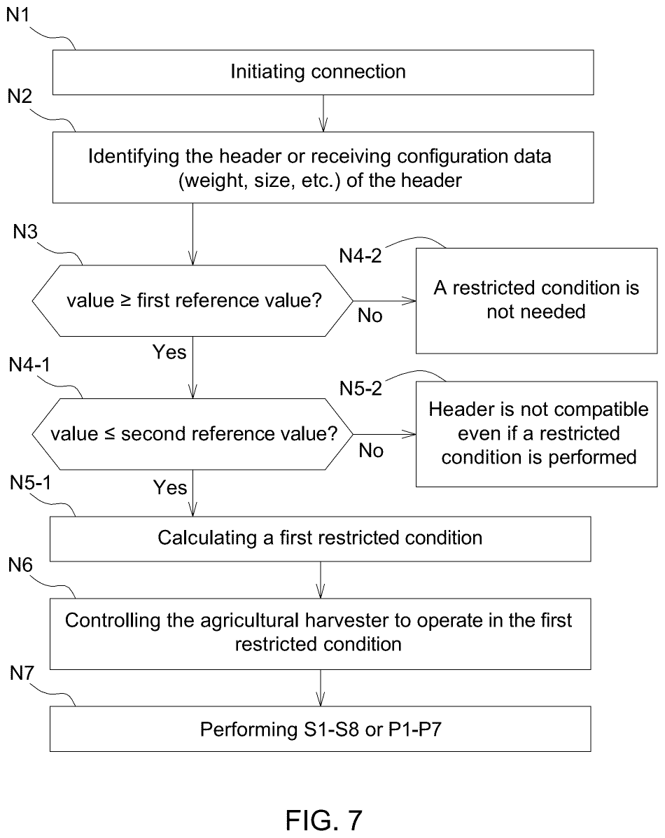

Referring to FIG. 7, a method of compatibility control of the agricultural harvester 20 briefly corresponding to the fourth implementation is illustrated.

N1: Initiating connection between the header and the body of the agricultural harvester.

N2: Identifying the header or receiving configuration data (weight, size, etc.) of the header.

N3: Comparing a value of the configuration data with a first reference value. If the value is equal to or greater than the first reference value, go to N4-1; if the value is less than the first reference value, go to N4-2

N4-1: Comparing the value of the configuration data with a second reference value. If the value is equal to or less than the second reference value, go to N5-1; if the value is greater than the second reference value, go to N5-2.

N4-2: The value less than the first reference value indicates a restricted condition is not needed. A display may notify this information to the operator.

N5-1: Calculating a first (initial) restricted condition. Optionally, the display may notify the content of the first restricted condition to the operator and request the operator's approval on the first restricted condition.

N5-2: The value greater than the second reference value indicates the header is not compatible even if a restricted condition is performed. The display may notify this information to the operator.

N6: Controlling the agricultural harvester to operate in the first restricted condition.

N7: Performing S1-S8 or P1-P7. The restricted condition will be updated during the operation of the agricultural harvester.

In the fifth implementation, like the third embodiment, the processor 72 utilizes the configuration data of the header 30 to calculate the restricted condition. In one example, when the header 30 is hooked on the body of the agricultural harvester 20, the sensor 67 may read or retrieve the identification data from the header 30 and transmit a signal indicative of the identity of the header 30 to the controller 70 to identify the header 30. After the type of the header 30 is identified, the controller 70 may retrieve the configuration data of the header 30 from the memory 74 or other sources (e.g., internet, cloud, etc.). In the fifth implementation, the value of the configuration data, for example, is the moment of inertia. As described previously, uneven ground condition included but is not limited to a rock, bump, dent, will lift or lower one side of the header 30 and cause an external twist load on the header 30 and the feederhouse 28. Assuming the uneven ground condition causes substantially the same angular acceleration, the header 30 with greater moment of inertia will have greater twist load or torque. It is noted that not only the weight of the header 30, but also the width of the header 30 determine the moment of inertia. The processor 72, by executing the compatibility control algorithm 742, compares values of the configuration data (i.e., moment of inertia) of the header 30, with the reference value(s), such as thresholds of the moment of inertia, pre-stored in the memory 74 to determine whether to calculate the restricted condition. The processor 72 is operable to determine, based on the configuration data, whether the values of the configuration data is equal to or greater than a first reference value (such as a moment of inertia threshold). If values of the configuration data is equal to or greater than a first reference value, the restricted condition may be calculated and performed to make the header 30 having great moment of inertia compatible. If the values of the configuration data is less than the first reference value, the restricted condition is not needed. In another example, when the header 30 is hooked on the body of the agricultural harvester 20, the electronic component 68 may be electronically connected to the controller 70 to upload the configuration data to the controller 70. Like previous example in this paragraph, the processor 72 compares values of the configuration data, such as the mass moment of inertia of the header 30, with the reference value(s) pre-stored in the memory 74 to determine whether to calculate the restricted condition to make the header 30 having greater inertia compatible.

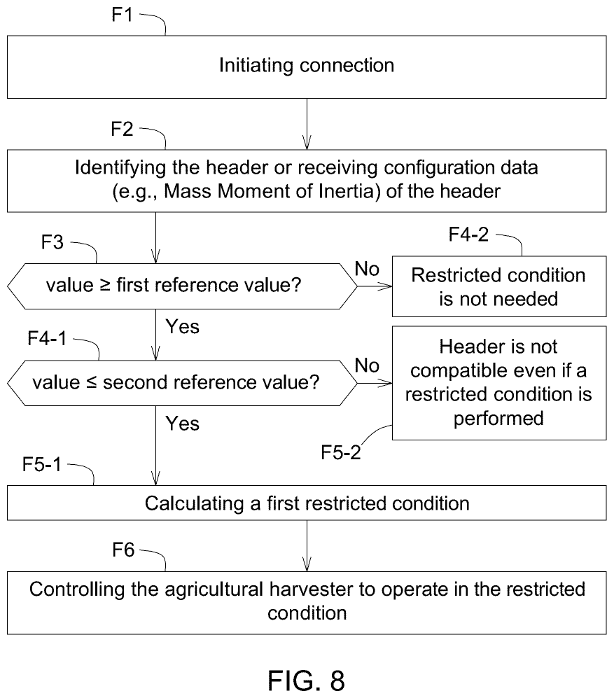

Referring to FIG. 8, a method of compatibility control of the agricultural harvester 20 briefly corresponding to the fifth implementation is illustrated.

F1: Initiating connection between the header and the body of the agricultural harvester.

F2: Identifying the header or receiving configuration data (mass moment of inertia) of the header.

F3: Comparing a value of the configuration data with a first reference value (first moment of inertia threshold). If the value is equal to or greater than the first reference value, go to F4-1; if the value is less than the first reference value, go to F4-2.

F4-1: Comparing the value of the configuration data with a second reference value (second moment of inertia threshold). If the value is equal to or less than the second reference value, go to F5-1; if the value is greater than the second reference value, go to F5-2.

F4-2: The value less than the first reference value indicates a restricted condition is not needed. A display may notify this information to the operator.

F5-1: Calculating a restricted condition. Optionally, the display may notify the content of the restricted condition to the operator and request the operator's approval on the restricted condition.

F5-2: The value greater than the second reference value indicates the header is not compatible even if a restricted condition is performed. The display may notify this information to the operator.

F6: Controlling the agricultural harvester to operate in the restricted condition.

In the sixth implementation, the processor 72 calculates the moment of inertia when there is no identification data or configuration data of the header 30 available or when there is a need to calculate the moment of inertia. Then the processor 72 calculates the restricted condition based on the value of the moment of inertia. In one example, the processor 72, by executing the compatibility control algorithm 742, controls the actuators (such as actuator 32) to lift the header 30 in an appropriate height and controls the hydraulic pressure controllers 527, 528, to change the hydraulic pressure of the tilt actuators 326, 328. As shown in FIG. 1F, one of the tilt actuators 326 or 328 extends and the other one tilt actuators 326 or 328 retracts, and then the retracted tilt actuator 326 or 328 extends and the extended tilt actuator 326 or 328 retracted. During the pivotal movement of the header 30, the processor 72 coupled to an angular position sensor, such as a potentiometer applied to the pivot unit defining the axis 284 and a timer to calculate the angular acceleration. There are other ways to measure or obtain the value of the angular acceleration. The twist load (Ft in FIG. 1G) applied from the tilt actuators 326, 328 is calculated by the hydraulic pressure of the tilt actuator 326, 328. The twist load times cosine θ and the length (2d) of the cross-sectional view of the feederhouse 28 equals to the torque Th (Ft*Cos (θ)*2*d=Th). The machine moment of inertia is calculated by the torque Th divided by the angular acceleration. The processor 72 compares the value of the moment of inertia of the header 30, with the reference value(s), such as thresholds of the moment of inertia, pre-stored in the memory 74, to determine whether to calculate the restricted condition. The processor 72 is operable to determine whether the value of the moment of inertia is equal to or greater than a first reference value (such as a moment of inertia threshold). If values of the configuration data is equal to or greater than a first reference value, the restricted condition may be calculated and performed to make the header 30 having great moment of inertia compatible. If the values of the moment of inertia is less than the first reference value, the restricted condition is not needed.

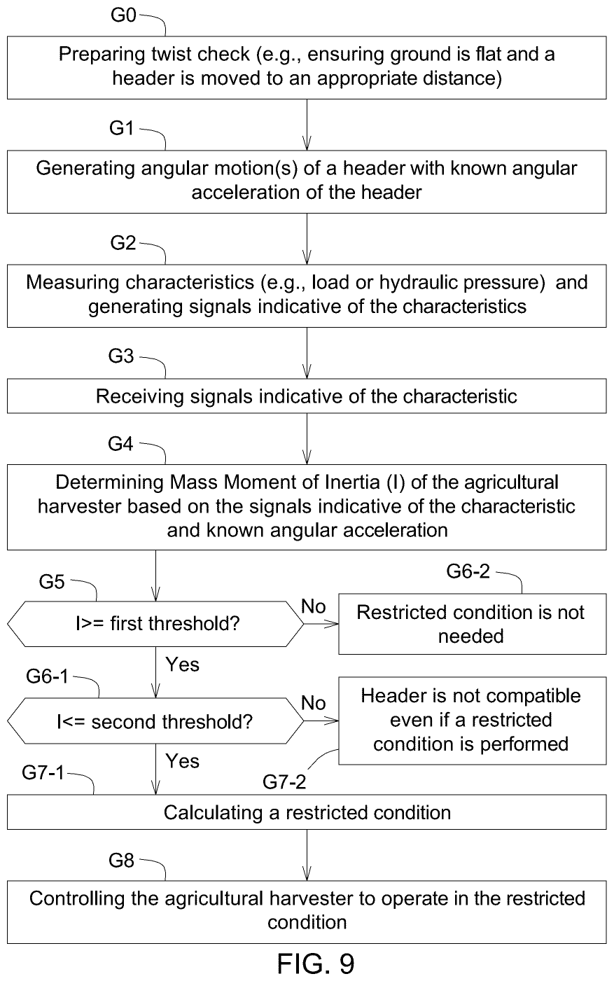

Referring to FIG. 9, a method of compatibility control of the agricultural harvester 20 briefly corresponding to the sixth implementation is illustrated.

G0: Preparing twist check (e.g., ensuring ground is flat and a header is moved to an appropriate distance).

G1: Generating angular motion(s) of a header with known angular acceleration of the header.

G2: Measuring characteristics (e.g., load or hydraulic pressure) and generating signals indicative of the characteristics.

G3: Receiving signals indicative of the characteristic.

G4: Determining a mass moment of inertia (I) of the header of the agricultural harvester based on the signals indicative of the characteristic and known angular acceleration.

G5: Comparing the value of the mass moment of inertia with a first reference value. If the value is equal to or greater than the first reference value, go to G6-1; if the value is less than the first reference value, go to G6-2.

G6-1: Comparing the value of the mass moment of inertia with a second reference value (second moment of inertia threshold). If the value is equal to or less than the second reference value, go to G7-1; if the value is greater than the second reference value, go to G7-2.

G6-2: The value less than the first reference value indicates a restricted condition is not needed. A display may notify this information to the operator.

G7-1: Calculating a restricted condition. Optionally, the display may notify the content of the restricted condition to the operator and request the operator's approval on the restricted condition.

G7-2: The value greater than the second reference value indicates the header is not compatible even if a restricted condition is performed. The display may notify this information to the operator.

G8: Controlling the agricultural harvester to operate in the restricted condition.

The seventh implementation may be a combination of a portion of the fifth implementation, a portion the sixth implementation, and other features such as comparing the twist load generated by the tilt actuators 326, 328. The twist load is generated though the of hydraulic pressure, measured by the sensors 614, 615 in the tilt actuators 326, 328 to simulate a potential twist load that may occur during operation. The hydraulic pressure measured by the sensors 614, 615, as described previously, may be used for the processor 72 to calculate the twist load. The processor 72 compares the twist load, with the reference value(s), such as thresholds of twist load, pre-stored in the memory 74, to determine whether to calculate the restricted condition.

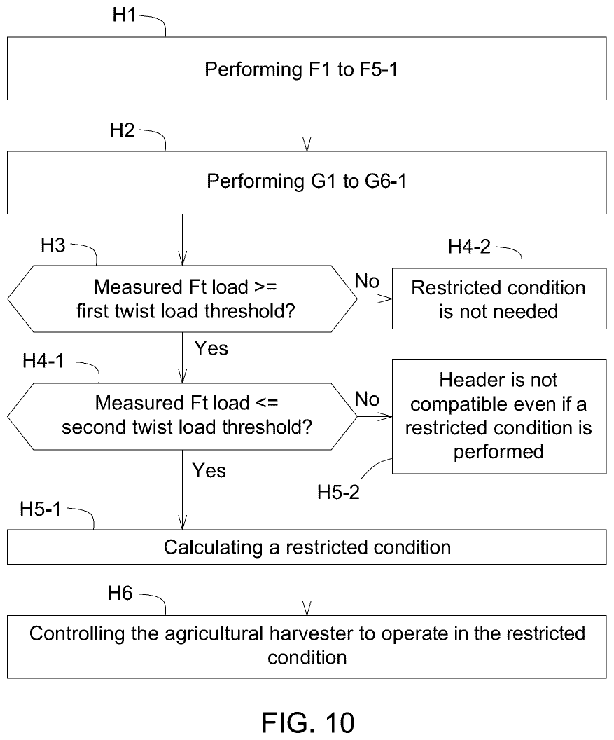

Referring to FIG. 10, a method of compatibility control of the agricultural harvester 20 briefly corresponding to the seven implementation is illustrated.

H1: Performing F1 to F5-1.

H2: Performing G1 to G6-1.

H3: Comparing a value of the measured twist load (Ft load) with a first reference value (first twist load threshold). If the value is equal to or greater than the first twist load threshold, go to H4-1; if the value is less than the first reference value, go to H4-2.

H4-1: Comparing the value of the measured twist load with a second reference value (second twist load threshold). If the value is equal to or less than the second reference value, go to H5-1; if the value is greater than the second reference value, go to H5-2.

H4-2: The value less than the first reference value indicates a further restricted condition is not needed. A display may notify this information to the operator.

H5-1: Calculating a restricted condition. Optionally, the display may notify the content of the restricted condition to the operator and request the operator's approval on the restricted condition.

H5-2: The value greater than the second reference value indicates the header is not compatible even if a restricted condition is performed. The display may notify this information to the operator.

H6: Controlling the agricultural harvester to operate in the restricted condition.

In the eighth implementation, during the operation of agricultural harvester 20, the controller 70 may calculate and update the restricted condition, based on the measured twist load detected by the sensors 614, 615.

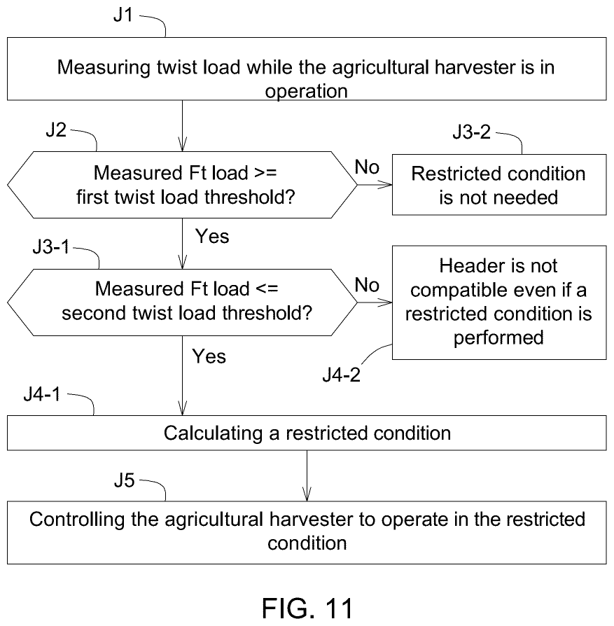

Referring to FIG. 11, a method of compatibility control of the agricultural harvester 20 briefly corresponding to the eighth implementation is illustrated.

J1: Measuring twist load while the agricultural harvester is in operation.

J2: Comparing a value of the measured twist load (Ft load) with a first reference value (first twist load threshold). If the value is equal to or greater than the first twist load threshold, go to J3-1; if the value is less than the first reference value, go to J4-2.

J3-1: Comparing the value of the measured twist load with a second reference value (second twist load threshold). If the value is equal to or less than the second reference value, go to J4-1; if the value is greater than the second reference value, go to J4-2.

J3-2: The value less than the first reference value indicates a restricted condition is not needed. A display may notify this information to the operator.

J4-1: Calculating a restricted condition. Optionally, the display may notify the content of the restricted condition to the operator and request the operator's approval on the restricted condition.

J4-2: The value greater than the second reference value indicates the header is not compatible even if a restricted condition is performed. The display may notify this information to the operator.

J5: Controlling the agricultural harvester to operate in the restricted condition.

Without in any way limiting the scope, interpretation, or application of the claims appearing below, a technical effect of one or more of the example embodiments/implementations disclosed herein is to determine whether a header attached to an agricultural harvester is compatible to the agricultural harvester. Another technical effect of one or more of the example embodiments/implementations disclosed herein is to make a heavier and/or larger header, with a reasonable range, still compatible to the body of the agricultural harvester under a restricted condition. Another technical effect of one or more of the example embodiments/implementations disclosed herein is to achieve the balance between the productivity (using wide, heavy header) and the life of the component(s) of the agricultural harvester, when the agricultural harvester is operated in the restricted condition.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally,” “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An agricultural harvester, comprising:
a main frame having a first end and a second end spaced from the first end along a central longitudinal axis of the main frame;
a ground engaging device coupled to the main frame and configured to move the main frame in a direction of travel during an operation;
a feederhouse coupled to the main frame and configured for attachment to a header;
a header compatibility control system including:
a first sensor configured to measure a characteristic of the agricultural harvester and to generate a signal indicative of the characteristic; and
a controller having a processor and a memory having a compatibility control algorithm stored therein, wherein the processor is operable to execute the compatibility control algorithm to:
receive the signal indicative of the characteristic from the first sensor to determine a load of the agricultural harvester;
determine, based on the signal, whether the load is equal to or greater than a first threshold, wherein the first threshold is stored in the memory;
calculate, if the load is determined to be equal to or greater than the first threshold, a restricted condition based on the load; and
control the agricultural harvester to operate in the restricted condition in response to the load being equal to or greater than the first threshold.

2. The agricultural harvester of claim 1, wherein the processor is operable to execute the compatibility control algorithm to:
determine, based on the signal, whether the load is equal to or less than a second threshold, which is stored in the memory; and
control the agricultural harvester to operate in the restricted condition in response the load being equal to or less than the second threshold.

3. The agricultural harvester of claim 1, wherein, in the restricted condition, the processor is operable to execute the compatibility control algorithm to restrict the agricultural harvester to travel at or below a pre-determined speed.

4. The agricultural harvester of claim 3, wherein the processor is operable to execute the compatibility control algorithm to downshift gears of a gearbox of the agricultural harvester or to initiate a brake of the ground engaging device to restrict the agricultural harvester to travel at or below the pre-determined speed.

5. The agricultural harvester of claim 3, wherein, in the restricted condition, the processor is operable to execute the compatibility control algorithm to decrease an output of a motor of the agricultural harvester to restrict the agricultural harvester to travel at or below the pre-determined speed.

6. The agricultural harvester of claim 1, further comprising: an actuator coupled between the feederhouse and the main frame, wherein the feederhouse is pivotably coupled to the main frame about a pivot axis, and the actuator is configured to lift and lower the feederhouse.

7. The agricultural harvester of claim 6, wherein the processor is configured to calculate a load of the header based on the signal from the first sensor.

8. The agricultural harvester of claim 7, wherein, in the restricted condition, the processor is operable to execute the compatibility control algorithm to extend or retract the actuator to lower a height of the header equal to or below a pre-determined height.

9. The agricultural harvester of claim 7, wherein the load of the header results from the weight of the header and a reaction from the crop material engaged with the header.

10. The agricultural harvester of claim 6, further comprising: a hydraulic pressure controller hydraulically connected to the actuator,
wherein the hydraulic pressure controller is coupled to the controller and configured to control a hydraulic pressure of a hydraulic fluid entering the actuator, and
wherein, in the restricted condition, the processor is operable to execute the compatibility control algorithm to activate the hydraulic pressure controller to restrict the hydraulic pressure to be equal to or less than a first hydraulic pressure value.

11. The agricultural harvester of claim 10, wherein the hydraulic pressure controller includes a pressure regulating valve disposed upstream the actuator and wherein the processor is operable to execute the compatibility control algorithm to adjust the hydraulic pressure of the fluid entering the actuator.

12. The agricultural harvester of claim 10, wherein the hydraulic pressure controller includes a flow control valve and an accumulator disposed downstream the flow control valve, and
wherein the processor is operable to execute the compatibility control algorithm to control the flow control valve to restrict the hydraulic pressure of the actuator to be equal to a first hydraulic pressure of the accumulator.

13. The agricultural harvester of claim 5, further comprising a position sensor configured to measure a position of the feederhouse and to transmit a signal indicative of the position of the feederhouse, and
wherein the processor calculates a moment based on the signal from the first sensor and the signal from the position sensor.

14. The agricultural harvester of claim 1, further comprising an axle coupled between the main frame the ground engaging device, wherein the first sensor is coupled to the axle to measure a characteristic of the axle.

15. The agricultural harvester of claim 1, further comprising:
an input device coupled to the controller and configured to transmit a signal indicative of an input to the controller; and
an operation sensor configured to detect an operational parameter of the agricultural harvester and transmit a signal indicative of the operational parameter to the controller,
wherein the memory includes an operation state classifier algorithm stored therein, and
wherein the processor is operable to execute the operation state classifier algorithm to classify an operation state derived from the signal indicative of the input and the signal indicative of the operational parameter and to execute the compatibility control algorithm to calculate the restricted condition based on the operation state.

16. The agricultural harvester of claim 15, wherein the operation state includes at least one of harvesting parallel to rows, angled to rows, brake assisted turns, field transport, field exits, road transport, and field border crossing.

17. The agricultural harvester of claim 1, further comprising an image sensor configured to capture an image of a ground in front of the agricultural harvester and to transmit a signal indicative of the image to the controller, and
wherein the processor is operable to execute the compatibility control algorithm to calculate the restricted condition based on the signal indicative of the image.

18. The agricultural harvester of claim 1, further comprising: an input device coupled to the controller and configured to input a travel path,
wherein the memory stores a topographic map covering a field, and
wherein the processor is operable to execute the compatibility control algorithm to extract data from the topographic map corresponding to the travel path to obtain the data of a topographic feature along the travel path and to calculate the restricted condition based on the data of the topographic feature.

19. The agricultural harvester of claim 18, wherein the topographic feature includes at least one of sizes of bumps, distances between the bumps, a slope of the travel path, a rate of a change of the slope, and a hardness of the soil.

20. The agricultural harvester of claim 1, wherein in the restricted condition, the controller is configured to restrict the agricultural harvester to travel at or below a pre-determined speed and to decrease the height of the header equal to or less than a pre-determined height.

21. The agricultural harvester of claim 1, wherein the header is an extendable header, and in the restricted condition, the processor is operable to execute the compatibility control algorithm to decrease a length of the header to a pre-determined length of the header.

22. An agricultural harvester, comprising:
a main frame having a first end and a second end spaced from the first end along a central longitudinal axis of the main frame;
a ground engaging device coupled to the main frame and configured to move the main frame in a direction of travel during an operation;
a feederhouse coupled to the main frame and configured for attachment to a header;
a header compatibility control system including:
a first sensor configured to measure a characteristic of the agricultural harvester and to generate a signal indicative of the characteristic; and
a controller having a processor and a memory having a compatibility control algorithm stored therein, wherein the processor is operable to execute the compatibility control algorithm to:
receive the signal indicative of the characteristic from the first sensor to determine a load of the agricultural harvester;
convert the load into a moment;
determine, based on the signal, whether the moment is equal to or greater than a first threshold, wherein the first threshold is stored in the memory;
calculate, if the moment is determined to be equal to or greater than the first threshold, a restricted condition based on the moment; and
control the agricultural harvester to operate in the restricted condition in response to the moment being equal to or greater than the first threshold.

23. The agricultural harvester of claim 22, wherein the processor calculates a moment based on the signal from the first sensor and a position of the feederhouse.

24. The agricultural harvester of claim 22, wherein the processor is operable to execute the compatibility control algorithm to:
determine, based on the signal, whether the moment is equal to or less than a second threshold, which is stored in the memory; and
control the agricultural harvester to operate in the restricted condition in response to the moment being equal to or less than the second threshold.

25. A method of compatibility control of an agricultural harvester comprising:
measuring a characteristic of the agricultural harvester and generating signals indicative of the characteristic by a first sensor;
receiving a signal indicative of the characteristic;
determining a load of the agricultural harvester based on the signal indicative of the characteristic;
converting the load into a moment;
comparing the moment with a first threshold;
calculating a restricted condition based on the moment in response to the moment being greater than the first threshold; and
controlling the harvester to operate in the restricted condition.
